(19) United States
(12) Patent Application Publication
(10) Pub. No.: US 2026/0230392 A1
(43) Pub. Date: Aug. 6, 2026

(54) INFERRING HARDWARE ARCHITECTURES TO PERFORM WORKFLOWS AT SCALE

(71) Applicant: Nvidia Corporation, Santa Clara, CA (US)

(72) Inventors: Siddha Ganju, San Jose, CA (US); Ryan Albright, Beaverton, OR (US); Elad Mentovich, Tel Aviv (IL); Gal Ashkenazi, Tel Aviv (IL); William Andrew Mecham, Elk Grove, CA (US); Benjamin Goska, Portland, OR (US); Jordan Levy, Portland, OR (US); William Ryan Weese, Portland, OR (US); Scott Millward, San Jose, CA (US)

(21) Appl. No.: 19/047,310

(22) Filed: Feb. 6, 2025

(51) Int. Cl. H04L 41/14; H04L 41/0823; H04L 41/16

(52) U.S. Cl. CPC H04L 41/145; H04L 41/0823; H04L 41/16

(57) ABSTRACT

Systems and methods disclosed herein can be used to determine an architecture of a data center based on one or more criteria. A system generates a digital representation of a data center, simulates how the digitally represented data center would perform under a certain workflow, and determines which of the simulated data centers satisfies the one or more criteria.

### TECHNICAL FIELD

This disclosure relates to simulating data center architectures and determining the performance of the architectures based on one or more criteria.

### BACKGROUND

Physical data centers may be organized into one of many architectures to optimize workflows. For example, data center architecture A may be better suited to running a workflow than data center architecture B. However, the current technology used to find a suitable data center architecture for specific tasks is inefficient. When users want to run new workflows, they have to adapt existing workflows to fit into established data center architectures or create a new architecture themselves, which can be time-consuming and prone to error.

### BRIEF DESCRIPTION OF DRAWINGS

Various embodiments in accordance with the present disclosure will be described with reference to the drawings, in which:

FIG. 1 illustrates a system architecture according to at least one embodiment;

FIG. 2 illustrates a model training system according to at least one embodiment;

FIG. 3 illustrates a computing system according to at least one embodiment;

FIG. 4 illustrates a system for simulating a data center environment according to at least one embodiment;

FIG. 5A illustrates a process for simulating a data center environment according to at least one embodiment;

FIG. 5B illustrates a process for training a machine learning model according to at least one embodiment;

FIG. 5C illustrates a process for simulating a data center environment according to at least one embodiment;

FIG. 6A illustrates a method for simulating a data center environment according to at least one embodiment;

FIG. 6B illustrates a method for simulating a data center environment according to at least one embodiment;

FIG. 6C illustrates a method for simulating a data center environment according to at least one embodiment;

FIG. 6D illustrates a method for simulating a data center environment according to at least one embodiment;

FIG. 7A illustrates inference and/or training logic, according to at least one embodiment;

FIG. 7B illustrates inference and/or training logic, according to at least one embodiment;

FIG. 7C illustrates components of a distributed system that can be utilized to update or perform inferencing using a machine learning model, according to at least one embodiment;

FIG. 8 illustrates an example data center system, according to at least one embodiment;

FIG. 9 illustrates a computer system, according to at least one embodiment;

FIG. 10 illustrates a computer system, according to at least one embodiment;

FIG. 11 illustrates at least portions of a graphics processor, according to one or more embodiments;

FIG. 12 illustrates at least portions of a graphics processor, according to one or more embodiments;

FIG. 13 is an example data flow diagram for an advanced computing pipeline, in accordance with at least one embodiment;

FIG. 14 is a system diagram for an example system for training, adapting, instantiating and deploying machine learning models in an advanced computing pipeline, in accordance with at least one embodiment;

FIG. 15A illustrates a data flow diagram for a process to train a machine learning model, as well as client-server architecture to enhance annotation tools with pre-trained annotation models, in accordance with at least one embodiment; and

FIG. 15B illustrates a data flow diagram for a process to train a machine learning model, as well as client-server architecture to enhance annotation tools with pre-trained annotation models, in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

This disclosure relates to the predicting of hardware architecture to use to run a new, but known and predictable, workflow. In at least one embodiment, a digital twin of a physical environment can be generated, such as by creating a simulation of a data center. Specifications about that data center can be added to the simulation software so that the simulation is an accurate representation of the way in which components of the data center would actually process a given workflow. The specifications can also include benchmark data regarding how certain jobs performed when run on certain hardware, and benchmark data on small jobs can be extrapolated to provide a reasonable estimate of the benchmark data for a larger version of that job if run at scale. The relevant workflow data can be fed to a machine learning (ML) model that is trained using the (real and/or synthetic) benchmark data, and the model can output one or more potential architectures to be used to run the simulation. A simulation can be performed using a large number of potential hardware architecture configurations in the data center, including architectures suggested by the trained model and variations thereof. The results of these simulations can be fed back to the trained neural network, which can analyze the simulation data, as well as the workflow information and data center specifications, and can refine its inferences as to optimal hardware architecture to perform the workflow. The simulations can be performed again using this updated proposed architecture (and potentially variations thereof), and a result of the simulation can be provided. The process can involve a number of iterations, until either no further improvements can be made or a target level of performance (or other such criterion) has been met or satisfied. The number of iterations in at least one embodiment can depend in part on the amount and accuracy of available benchmark data that can be used to make inferences as to optimal architecture. This can include, for example, inferring the number and types of processing clusters to be used for a specific type of HPC job. Updated real and synthetic performance and benchmark data can be used to further train or fine-tune the ML model. Examples of workflows that can benefit from such a process, as they will involve long-running but predictable jobs, include SFT, PEFT, and other LLM-based jobs, for both inferencing and training. In some embodiments, instead of outputting a single architecture selection, the process can output a graph or set of options with different performance metrics, such as cost and performance, and a user can select an architecture from there, such as may provide the maximum performance within an available budget. A user may also be able to use an LLM or other such mechanism to query the system to make adjustments to the budget, types of hardware that can be used, etc.

The systems and methods described herein provide an advancement in the field of data center optimization through the use of ML models to predict optimal hardware architectures for specific workflows. By incorporating inputs such as configuration data, telemetry data, data center architectures, hardware architectures, and performance data, the system creates a comprehensive digital twin of the physical data center environment. This digital twin allows for precise modeling of how various components in the data center will perform with predictable workflows, enabling users to make more accurate predictions as compared to previous technologies that relied on static benchmarks or simplistic assumptions. Furthermore, the iterative nature of feeding simulation results back into the ML model enhances its ability to refine and improve its predictions over time. As a result, these systems and methods not only improve upon existing technologies by providing tailored solutions based on real-time analysis but also significantly reduce trial-and-error inefficiencies.

Furthermore, the systems and methods described herein significantly enhance the accuracy in predicting optimal hardware architectures for workflows by creating a detailed digital twin of the data center. The model can simulate real-world interactions between various components and workloads with high fidelity. This allows for precise extrapolation of performance data, ensuring that the predictions are not only based on theoretical assumptions but also on empirical evidence gathered from actual operations. The iterative feedback loop—where simulation results inform and refine the model—ensures continuous improvement in accuracy over time.

In addition to improving accuracy, machine learning-based embodiments may enhance efficiency. By automating the process of simulating multiple hardware architecture configurations and iteratively refining these simulations based on performance outcomes, organizations can significantly reduce the time spent on testing and trial-and-error methods. The ability to quickly generate a range of architectural options—complete with varying cost-performance metrics—allows users to make informed decisions without having to exhaustively evaluate each possibility individually. Furthermore, by utilizing both real-time telemetry data and historical benchmarks within its calculations, the system can rapidly identify optimal configurations that align with current operational constraints such as budget or resource availability. This streamlined decision-making process not only accelerates deployment timelines but also maximizes resource utilization within data centers, making it an effective solution for organizations aiming to enhance their operational workflows while minimizing costs associated with inefficient hardware allocation.

Variations of this and other such functionality can be used as well within the scope of the various embodiments as would be apparent to one of ordinary skill in the art in light of the teachings and suggestions contained herein.

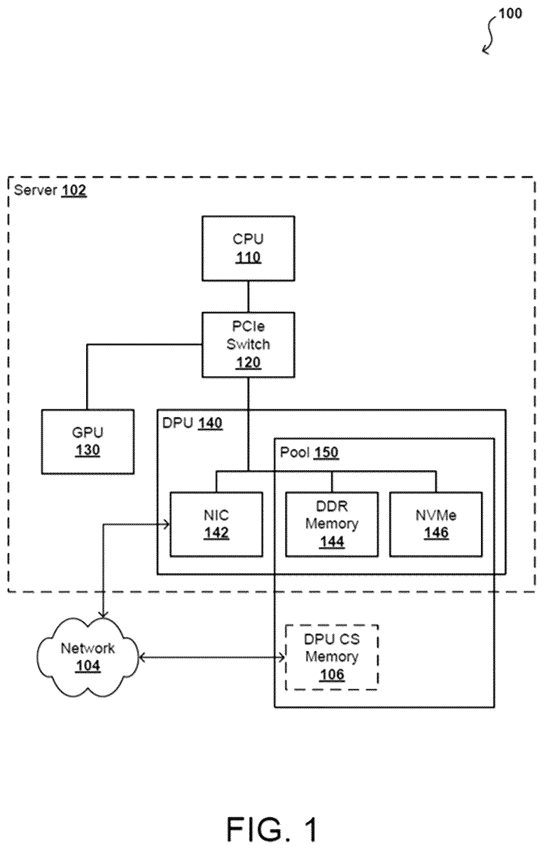

FIG. 1 illustrates an example computing environment 100 in which forward pass offloading to available memory can be performed, in accordance with at least one embodiment. It should be appreciated that embodiments of the present disclosure may also be used with reference to alternative environments and that specific discussion of components may be provided by way of non-limiting examples and may include equivalents. Moreover, various features have been removed for clarity and conciseness. Additionally, systems and methods may be used with a variety of different architectures. The example computing environment 100 may include a server 102 which may be used to perform HPC workloads, such as AI training or machine learning model training. In an embodiment, the server 102 may be an application instance or a compute node. The server 102 may include a CPU 110 associated with a switch 120, such as a peripheral component interconnect express (PCIe) switch, which may control at least some data transmission over communication paths interconnecting various components. In an embodiment, the CPU 110 may include a root complex processor.

The PCIe switch 120 may also be associated with a GPU 130 and a DPU 140, and may transmit data between at least some of the CPU 110, the GPU 130, the DPU 140, and other components. In an embodiment, the PCIe switch 120 may be associated with more than one GPU or more than one DPU. In another embodiment, the PCIe switch 120 may be located within the DPU 140. The PCIe switch 120 may manage the transfer of at least some data between the CPU 110, the GPU 130, and the DPU 140. In another embodiment, the number of GPUs associated with the PCIe switch 120 may be equal to the number of DPUs associated with the PCIe switch 120. In at least one embodiment, the server 102 may include, without limitation, any number of the CPUs 110, the PCIe switches 120, the GPUs 130, and/or the DPUs 140, in any combination. For example, in at least one embodiment, server 102 could include eight, sixteen, thirty-two, and/or more GPUs 130. In at least one embodiment, communication paths interconnecting various components, including but not limited to the CPU 110, the PCIe switch 120, the GPU 130, and the DPU 140, in FIG. 1 may be implemented using any suitable protocols, such as peripheral component interconnect (PCI) based protocols (e.g., PCIe), or other bus or point-to-point communication interfaces and/or protocol(s), such as NV-Link high-speed interconnect, or interconnect protocols.

The DPU 140 may include a network interface card (NIC) 142, a DDR memory 144, and a non-volatile memory express (NVMe) device 146. The NIC 142 may be able to interface with a network 104, which may also interface with additional NVMe devices available to the DPU 140, such as over fabric. In an embodiment, the DPU 140 may not include the NVMe device 146. In another embodiment, the NVMe device 146 may be located on the server 102 and not on the DPU 140. In yet another embodiment, the computing environment 100 may include more than one of the NVMe devices 146, such as a first NVMe device in the DPU 140 and a second first NVMe device on the server 102 and associated directly with the PCIe switch 120. In an embodiment, the DPU 140 may not include the DDR memory 144 and may include a computational storage service (CSS) in place of, or in addition to, the DDR memory 144. For example, computing environment 100 may include DPU computational storage (CS) memory 106 available to the DPU 140 as part of the CSS. The network 104 may be able to interface with the DPU CS memory 106 through the NIC 142, according to any suitable interface protocol, such as remote direct memory access (RDMA) over Ethernet, InfiniBand, Fiber Channel, etc.

The total memory of the computing environment 100 available for data storage may be expanded through the use of the DPU 140 on nodes of the system. The DPU 140 may have access to a pool 150 of memory already available to the server 102, such as double data rate (DDR) memory, on-board NVMe devices, NVMe devices over fabric, and CS. The pool 150 of memory may include at least one of the DDR memory 144, NVMe 146, and the DPU CS memory 106. The DPU 140 may also be able to access the available memory of other DPUs as part of the pool 150, and other DPUs may be able to access the available memory of DPU 140, such as the pool 150. This available memory can be accessed and utilized for data storage, without the addition of compute resources, such as compute nodes, which would be required using other solutions. The available pool 150 accessible to the DPU 140 may be provisioned for the server 102 to expand the total memory available for data storage, such as to reduce the data storage load on the CPU 110 or the GPU 130, which can instead increase the utilization of their memory for processing. For example, during training of an AI, the model states, residual states, activation functions, and checkpoints can be stored, or offloaded, on the pool 150 accessible to the DPU 140.

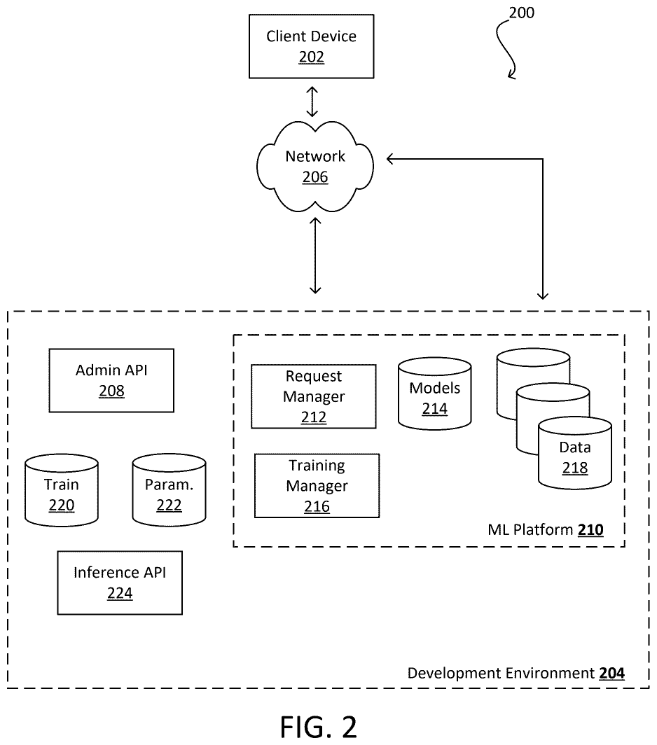

FIG. 2 illustrates an environment 200 that may be utilized with one or more server or computing systems in order to develop models. It should be appreciated that the environment may include more or fewer components and that various components of the environment 200 may be incorporated into singular systems, but may be shown as separate modules for convenience and clarity. In this example, a client device 202 may make one or more requests to a development environment 204 via one or more networks 206. The networks 206 may be wired or wireless networks which include one or more intermediate systems, such as user devices, server components, switches, and the like.

In this example, the development environment 204 may be associated with a platform that may offer one or more hosting or compute services for users, among other options such as simulating data center architecture. For example, the development environment 204 may enable a user to leverage one or more machine learning systems, such as conversational artificial intelligence (AI) systems, for integrated use with one or more of their products. The development environment 204 may enable the user to develop their own models for their desired purposes, to leverage existing models, or combinations thereof. Furthermore, the development environment 204 may also provide services such as model training, model verification, and the like. It should be appreciated that the development environment 204 may be integrated into a larger service environment which may provide various one-time or subscription based services to users. Furthermore, the development environment 204 may be associated with one or more software development toolkits (SDKs) to build applications for specific platforms.

Illustrated within the development environment 204 is administrator API 208 that may receive one or more requests submitted by the client device 202. The administrator API 208 may provide an interface for the client device 202 to interact with, such as to submit requests for new machine learning systems, to edit or adjust properties of existing machine learning systems, to run diagnostics, and the like. In at least one embodiment, the administrator API 208 may be associated with a service provided to the client device 202 associated with hosting and/or operation of machine learning systems, among other options.

In at least one embodiment, a machine learning platform 210 is associated with the development environment 204. The machine learning platform 210 may include one or more tools to enable users to establish, train, and/or operate various machine learning systems for a variety of applications. For example, users may leverage existing models, such as a general purpose model that has trained on a large data set, and then fine tune or otherwise train the model for a task specific operation. A request manager 212 may receive requests, such as from the administrator API 208 to adjust to select a model, or from the client device 202 to execute one or more operations using an established model. The request manager 212 may select one or more models from model database 214. The model database 214 may include a set of general purpose models and/or task specific models. In at least one embodiment, previously trained and developed models associated with the user may be stored in the model database 214 for later access and/or changes. For example, a user may have a variety of different models for different applications, and different models may be accessed and used at different times.

The machine learning platform 210 may also be utilized to develop new models. For example, one or more models, such as a general purpose model from the model database 214, may go through a training process where a training manager 216 selects data 218 to train the model. For example, the training manager 216 may select one or more datasets related to a task specific application. Additionally, in at least one embodiment, the training manager 216 may select how many training passes are made, parameters associated with training, and the like.

In at least one embodiment, users may provide training data for use with training operations, which may be stored in a database 220. For example, the user may bring their own datasets or may generate new datasets through saving different operations associated with one or more models. The database 220 may be utilized for task specific training of one or more models. Furthermore, users may provide parameters 222 for storage and use by the training manager 216 and/or the request manager 212 when establishing or using a model. The parameters 222 may include specific classes associated with models, desired accuracy levels, latency, and the like.

In operation, user requests may take the form of an input query, such as a question for a conversational system, which may interact with an inference API 224. The inference API may interface with the machine learning platform 210, such as to present questions for evaluation and then provide answers back to the user.

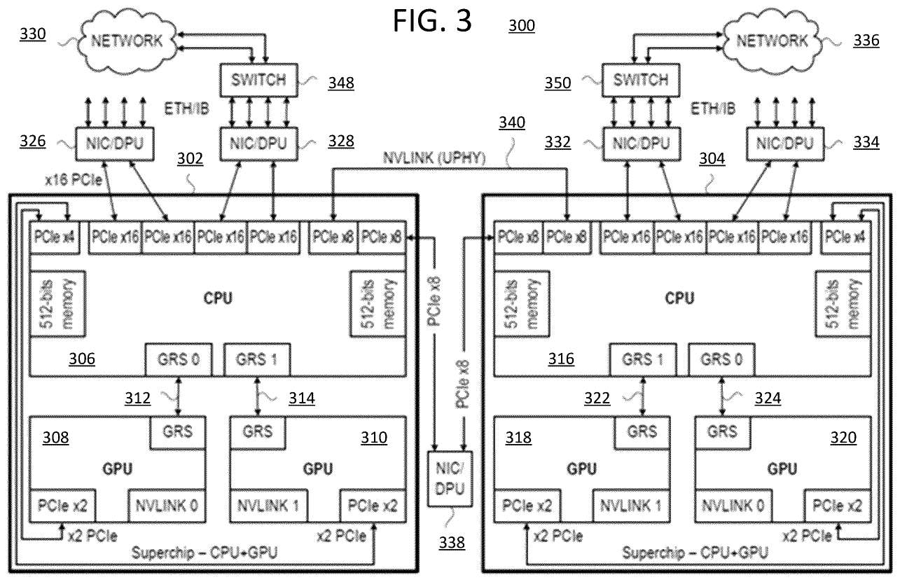

FIG. 3 is a block diagram that schematically illustrates a computing system 300, e.g., a data center or a High-Performance Computing (HPC) cluster, in accordance with an embodiment that is described herein. Computing system 300 comprises a plurality of subsystems, e.g., multiple processing devices coupled to each other, multiple network devices, and multiple networks, according to at least one embodiment. Computing system 300 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 300 and to one or more external networks 330, 336. In the present example, computing system 300 comprises a packet switch 348 that connects NIC/DPU 328 to network 330, and a packet switch 350 that connects NIC/DPU 332 to network 336.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the electronic device 1000 can include one or more CPUs and one or more GPUs.

FIG. 3 also demonstrates an example architecture of a multi-GPU architecture. As illustrated in the figure, computing system 300 includes a processing device 302 with a multi-GPU architecture. In particular, processing device 302 may be a system-on-chip and includes multiple subsystems such as a CPU 306, a GPU 308, and a GPU 310. CPU 306 can be coupled to GPU 308 via a die-to-die (D2D) or chip-to-chip (C2C) interconnect 312, such as a Ground-Referenced Signaling interconnect (GRS interconnect). CPU 306 can be coupled to GPU 310 via a D2D or C2C interconnect 314. CPU 306 can also couple to GPU 308, and GPU 310 via PCIe interconnects.

CPU 306 can be coupled to one or more NICs or DPUs, which are coupled to one or more networks. For example, as illustrated in FIG. 3, CPU 306 is coupled to a first NIC/DPU 326, which is coupled to a network 330. CPU 306 is also coupled to a second NIC/DPU 328, which is coupled to network 330 via switch 348. NIC/DPU 326 and NIC/DPU 328 can be coupled to network 330 over Ethernet (ETH), NVLINK or InfiniBand (IB) connections, for example.

Computing system 300 also includes a processing device 304 with a multi-GPU architecture. In particular, processing device 304 includes multiple subsystems including a CPU 316, a GPU 318, and a GPU 320. CPU 316 can be coupled to GPU 318 via an D2D or C2C interconnect 322. CPU 316 can be coupled to GPU 320 via a D2D or C2C interconnect 324. CPU 316 can also couple to GPU 318, and GPU 320 via PCIe interconnects. CPU 316 can be coupled to one or more NICs or DPUs, which are coupled to one or more networks. For example, as illustrated in FIG. 3, CPU 316 is coupled to a first NIC/DPU 332, which is coupled to a network 336. CPU 316 is also coupled to a second NIC/DPU 334, which is coupled to network 336 via switch 350. NIC/DPU 332 and NIC/DPU 334 can be coupled to network 336 over Ethernet (ETH), NVLINK or InfiniBand (IB) connections.

In at least one embodiment, processing device 302 and processing device 304 can communicate with each other via a NIC/DPU 338, such as over PCIe interconnects. Processing device 302 and processing device 304 can also communicate with each other over a high-bandwidth communication interconnects 340, such as an NVLink interconnect or other high-speed interconnects. The packet switches in FIG. 3 may comprise, for example, Nvidia Quantum-2 switches. The NICs/DPUs in the figure may comprise, for example, Nvidia Bluefield DPUs.

In various embodiments, any of the network devices of computing system 300, e.g., any of NICs/DPUs 326, 328, 332, 334, and 338, and/or any of switches 348 and 350, may use ILI packets in accordance with the techniques described herein.

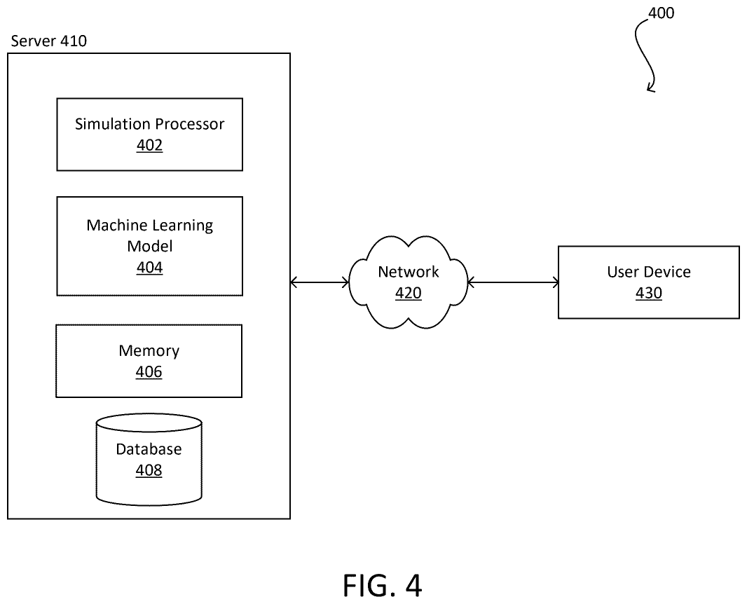

FIG. 4 illustrates a system 400 for simulating data center architectures and related hardware architectures according to at least one embodiment. The system 400 may include without limitation a server 410, a network 420, and a user device 430. The server 410 may include a simulation processor 402, machine learning model 404, memory 406, and database 408.

A user associated with the user device 430 may want to find a data center architecture to run the user's unique workflow. The user may base their search on several criteria, including without limitation target cost, power consumption, available space, thermal management, latency, scalability, level of performance, number of processing nodes to be used to perform the workflow, and other considerations. In other example embodiments, the user may want to run multiple workflows on the same architecture. A workflow may relate to a job that is to be run for at least a minimum period of time and has an anticipated load over the minimum period of time. The user device 430 associated with the user may transmit workflow information and criteria information to the server 410 over the network 420 so that the server 410 may simulate the user's workflow and criteria on a number of digitally represented data centers for the purpose of determining which digitally represented data center can perform the user's workflow according to one or more criteria.

The server 410, having received the workflow information and criteria information, may generate a digital representation of one or more data centers via the simulation processor 402. The simulation processor 402 may perform one or more actions described herein by reading one or more instructions stored in the memory 406.

The simulation processor 402 is any computing processor such as a central processing unit (CPU) configured to execute instructions and perform calculations, as well as multiple cores to facilitate parallel processing, one or more digital signal processors (DSPs) for handling specific types of data such as audio and video signals, and application-specific integrated circuits (ASICs) designed for particular tasks. Additionally, the simulation processor 402 may integrate cache memory to enhance data retrieval speeds, support various instruction set architectures (ISAs), and utilize hardware components such as arithmetic logic units (ALUs), control units, and registers to perform fundamental operations. Furthermore, the simulation processor 402 may incorporate graphics processing units (GPUs) for rendering images and performing complex computations efficiently or field-programmable gate arrays (FPGAs) that allow reconfiguration for specialized applications.

The memory 406 may include volatile memory such as random access memory (RAM), non-volatile memory types, including read-only memory (ROM) for firmware storage, flash memory for solid-state drives (SSDs) and USB drives, magnetic storage such as hard disk drives (HDDs) for long-term data retention, cache memory, dynamic RAM (DRAM), static RAM (SRAM), double data rate synchronous dynamic RAM (DDR SDRAM), resistive RAM (ReRAM), and phase-change memory (PCM). The memory 406 may also extend to any form of data storage or retrieval mechanism within a computing system, including virtual memory systems that utilize disk space to extend available RAM.

The server 410 or simulation processor 402 may store the workflow and criteria information in the database 408 for long-term storage. The database 408 may include, in example embodiments, a structured collection of data that is organized for efficient storage, retrieval, and management. The database 408 may include: a data model such as the relational model, which organizes data into tables consisting of rows and columns; one or more persistent storage mechanisms using hard disk drives (HDDs), solid-state drives (SSDs), or other non-volatile memory solutions; and files managed by a database management system (DBMS). When the simulation processor 402 needs to retrieve information from the database, it may issue queries written in query languages such as without limitation Structured Query Language (SQL).

The simulation processor 402 may input the workflow information to the machine learning model 404. The machine learning model 404 may receive the workflow as one or more inputs and generate one or more data center architectures or hardware architectures as one or more outputs. The digital representation of the data center may include a two-dimensional, three-dimensional, or otherwise multi-dimensional model that depicts the physical layout and components of the data center. In some example embodiments, the digital representation is a digital twin of the physical data center including a virtual three-dimensional representation of a set of connected functional components of the physical data center. The representation may include, as various virtual objects, servers, server racks, and networking equipment, as well as structural elements like walls, hallways, cold aisles, and hot aisles. The representation may further include different clusters of compute nodes in the physical data center, a number of the compute nodes in the different clusters being greater than were used to previously perform a similar workflow at a smaller scale. The simulation processor 402 may employ geometric modeling to define the dimensions and spatial relationships of these objects, while texture mapping enhances visual fidelity by applying surface details to the models. Furthermore, environmental factors such as air conditioning units and ventilation systems can be integrated into the representation to simulate airflow dynamics within the space. In example embodiments, by leveraging technologies such as computer-aided design (CAD) software or 3D graphics engines, the simulation processor 402 may integrate this information into an interactive visualization that allows for real-time manipulation and analysis of the data center's layout and operational efficiency.

The machine learning model 404 may be trained by the system with further reference to FIG. 2. In example embodiments, the machine learning model 404 may include a neural network architecture which consists of interconnected layers of nodes or neurons that enable the model to learn complex patterns and relationships within the input data. In other example embodiments, the machine learning model 404 may utilize algorithms such as decision trees, support vector machines, or ensemble methods to enhance predictive accuracy and robustness. Feature extraction techniques can be employed to identify relevant attributes from the software information, while optimization algorithms are used to fine-tune model parameters for improved performance. The machine learning model 404 may also integrate training and validation datasets to facilitate supervised learning processes, alongside mechanisms for cross-validation and hyperparameter tuning.

The simulation processor 402 receives the data center architectures or hardware architectures from the machine learning model 404. Based on these data center architectures or hardware architectures, the simulation processor 402 may execute one or more simulations on the data center architectures or hardware architectures within the digital representation. The simulations may simulate the performance of each of the data center architectures as they perform the workflow(s). In example embodiments, the simulation processor 402 may execute these simulations for the purpose of measuring the performance of each data center architecture based on one or more criteria received from the user device 430 or other relevant criteria. As a nonlimiting example, the simulation processor 402 may execute a simulation in which Data Center Architecture 1 performs a given workflow, and relatedly simulate how Data Center Architecture 1 performs with regard to latency, heat generation, and cost. In other embodiments, any one or more combinations of criteria described herein may be used.

In example embodiments, the simulations may analyze the performance of each data center architecture, including without limitation operational costs by estimating energy consumption based on the number and type of servers deployed, as well as cooling requirements for maintaining optimal temperatures. Heat production can be simulated by modeling airflow dynamics within the data center, allowing for assessments of hot and cold aisle configurations and their impact on cooling efficiency. Latency may be simulated by simulating network traffic patterns to determine how different layouts affect data transfer speeds between servers and storage units. Additionally, the simulations might consider redundancy strategies, such as the placement of backup power supplies or network connections, to assess their influence on uptime and reliability. By examining these factors in various architectural scenarios—such as varying server densities or differing rack arrangements—the simulation processor 402 can identify optimal configurations that balance performance with cost-effectiveness and energy efficiency.

Based on these simulations, the simulation processor 402 may collect one or more performance data on each simulated data center architecture. The performance data includes data indicating how each of the simulated data center architecture performed under a given workflow. In example embodiments, the performance data may indicate that Data Center Architecture 1 had relatively low latency but relatively high cost. The performance data may be collected by the simulation processor 402 continuously or in batches. In some example embodiments, the server 410 and/or simulation processor may store the performance data in the database 408 for long term storage.

In other example embodiments, the performance data may include telemetry data about data center architecture, the telemetry data including without limitation temperature readings at various locations within the data center, including server racks and HVAC units, to evaluate cooling effectiveness and identify potential hotspots. The simulation processor 402 may also monitor power consumption metrics, such as total kilowatt-hours used by individual servers and cooling systems, allowing for calculations of operational costs over time. Network latency measurements can be recorded to analyze the speed of data transfers between servers, with specific attention to round-trip times for critical applications. Additionally, the simulation processor 402 might collect utilization rates for CPU and memory resources across different configurations to determine how effectively hardware is being employed. Metrics related to resource availability, such as downtime incidents or failure rates of specific components, can also be observed to gauge reliability. By compiling this telemetry data, the simulation processor 402 can provide valuable insights into which architectural designs optimize performance while minimizing costs and energy consumption.

The simulation processor 402 may analyze the performance of each simulated data center architecture based on the performance data. The simulation processor 402 may determine, based on the performance data, which of the data center architectures, if any, satisfied the criteria set by the user. In example embodiments, the simulation processor 402 may determine that all criteria were met, or some criteria were met, or none were met. In other example embodiments, the simulation processor 402 may determine that one or more highly consequential criteria were met but other less consequential criteria were met, and vice versa. In some embodiments, the simulation processor 402 may determine that one or more data center architectures successfully meet one or more of the criteria set by the user. The server 410 and/or simulation processor 402 may transmit these data center architectures and any associated performance data to the user device 430 over the network 420. In example embodiments, the server 410 or simulation processor 402 may prompt the user device 430 to approve or reject the one or more data center architectures.

In some example embodiments, the simulation processor 402 may continue to generate more simulations of data center architectures if one or more criteria have not been met or if the user device 430 prompts the server 410 and simulation processor 402 to generate more simulations. In such example embodiments, the simulation processor 402 may input the given workflow, the performance data from the previous data center architectures, and any other suitable information into the machine learning model 404. The machine learning model 404, upon receiving these inputs, may analyze these inputs and generate additional data center architectures and/or hardware architectures as outputs. The machine learning model 404 may iterate this process one or more times. The simulation processor 402 may also provide inputs to the machine learning model 404 one or more times until a data center architecture satisfies one or more criteria, or until the user indicates that a certain data center architecture is chosen.

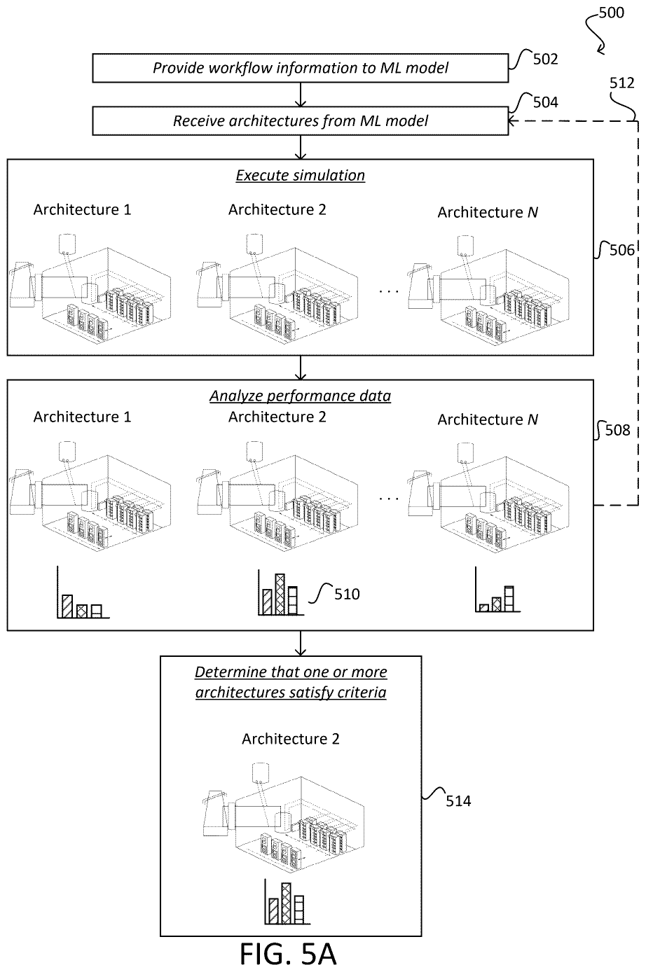

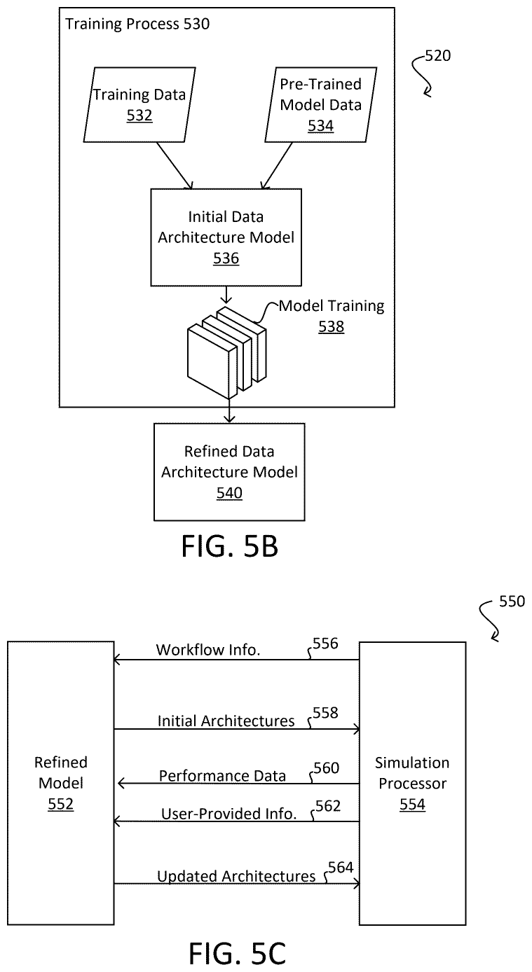

FIG. 5A illustrates a process 500 for simulating data center architectures and determining which data center architectures, if any, satisfy, one or more criteria. Each action in the process 500 may be performed by one or more processor and/or one or more servers. It should be appreciated that steps for the method may be performed in any order, or in parallel, unless otherwise specifically stated. Moreover, the method may include more or fewer steps.

A processor may provide 502 workflow information to a machine learning (ML) model. Workflow information may relate to a job that is to be run for at least a minimum period of time and has an anticipated load over the minimum period of time. The model may receive the workflow information as inputs, analyze these inputs, and generate one or more data center architectures or hardware architectures as outputs. The machine learning model 404 may include a neural network architecture, which consists of interconnected layers of nodes or neurons that enable the model to learn complex patterns and relationships within the input data. In other example embodiments, the machine learning model 404 may utilize algorithms such as decision trees, support vector machines, or ensemble methods to enhance predictive accuracy and robustness. Though not illustrated in FIG. 5A, the machine learning may be trained as described elsewhere herein.

The processor may receive 504 the architectures generated by the ML model. Based on these architectures, the processor may execute 506 simulations of the one or more data center architectures in a digital representation. In example embodiments, the processor may simulate Data Center Architecture 1, Data Center Architecture 2, and Data Center Architecture N. Although these architectures as illustrated are similar, it is understood that each architecture may include several differences. As a nonlimiting example, each data center architecture may include a unique configuration of power supply, servers, server racks, cold aisles, hot aisles, enclosures, enclosure busbars, power shelves, sleds, chasses, cooling units, switchgears, backup equipment, available space, arrangement of elements, room dimensions, thermal management, and other elements. In example embodiments, the digital representation and simulations are digital twins of the physical data center including a virtual three-dimensional representation of a set of connected functional components of the physical data center.

In these simulations, each architecture may be simulated to run one or more given workflow. These workflows may be given by a user or retrieved from a data storage unit. Each simulated data center architecture may run the workflow, and each data center architecture may perform differently based on each of their configurations. In example embodiments, each data center architecture may perform differently with regards to cost, power consumption, available space, thermal management, scalability, and other considerations. As the simulations perform the workflow, the processor gathers performance data about each data center architecture and analyzes 508 them. This analysis may include determining whether any of the data center architecture has met one or more criteria. In example embodiments, some of the data center architectures may perform well in all categories, some categories, or none. In other example embodiments, the criteria may be ranked in terms importance, e.g., cost being the most important criteria while sustainability is the least important, or any other such assignments of importance. The criteria may include without limitation target cost, power consumption, available space, thermal management, latency, scalability, level of performance, number of processing nodes to be used to perform the workflow, and other considerations. As the simulations run, the system may collect one or more performance data 510. Although illustrated as bar graphs in FIG. 5A, the performance data may take on any form such as without limitation raw or processed data.

The processor may determine 514 that one or more of the data center architecture satisfies one or more of the criteria and is a suitable candidate for the workflow. If, however, the processor determines that more additional data center architectures must be simulated—e.g., in response to none of the data center architecture meeting the criteria, or in response to the user indicating that they want more options—then the processor can iterate 512 the process again through actions 504 to 508 until one or more data center architectures perform well enough against the given criteria or are otherwise selected by the user.

FIG. 5B illustrates a process 520 for training a machine learning model to generate data center architectures and other hardware configurations according to a given workflow or other suitable input. The process 520 may include training process 530 for generating a refined data architecture model 540. The actions described in the process 520 may be performed by a server and/or one or more processors. It should be appreciated that steps for the method may be performed in any order, or in parallel, unless otherwise specifically stated. Moreover, the method may include more or fewer steps.

In the training process 530, training data 532 and other pre-trained model data 534 may be inputted to an initial data architecture model 536 for training the model to generate data center architectures and hardware architectures based on one or more inputs such as workflow, performance criteria, and other data center configuration data. The training data 532 may include data center architectures retrieved from a data storage unit or some other administrative device. In other example embodiments, at least some of the training data 532 may be artificially generated by a separate training data generation model. Although not illustrated in FIG. 5B, the training data 532 may undergo a labeling process where each of the training data 532 is labeled for the purpose of training the model. The labeling process may be performed automatically by a separate labeling model, manually by one or more users, or a mix of both. Additionally, pre-trained model data 534 may include data from one or more past data center architecture models. The use of the pre-trained model data 534 may accelerate the training of the model by inferring from this data one or more parameters for the model that achieve one or more goals such a minimizing loss, increasing accuracy, increasing efficiency, or some other metric.

An initial data architecture model 536 is generated by the system. This initial data architecture model 536 may undergo one or more iterations of model training 538. The model training 538 may include the iterative adjustments of one or more parameters in the initial architecture model 536 such as, without limitation, the weights and biases present in the model. These adjustments may be made any number of times across any number of iterations. The model training 538 may also include a loss model configured to calculate and minimize the loss or error of each iteration of the model. After a predetermined amount of training, the system may generate a refined data architecture model 540 which is capable of generating one or more data center architectures or hardware architectures according to a given workflow or other suitable inputs.

FIG. 5C illustrates a process 550 between a refined data architecture model 552 and a simulation processor 554. The actions in the process 550 may be performed within a server including one or both of the refined model 552 and simulation processor 554. It should be appreciated that steps for the method may be performed in any order, or in parallel, unless otherwise specifically stated. Moreover, the method may include more or fewer steps.

The simulation processor 554 may transmit 556 workflow information to the refined model 552. The workflow information may include data processing tasks such as batch processing for large datasets, real-time analytics for monitoring and responding to live data streams, and hosting web applications that require high availability and low latency. Additionally, workflows could encompass machine learning model training and inference tasks that demand substantial computational resources, as well as software development environments where continuous integration and deployment processes are executed. The simulation processor 554 may also share performance criteria and other configuration data with the refined model 552 so that the refined model 552 may generate architectures that meet these criteria and configurations.

The refined model 552 may generate one or more initial data center architectures or hardware architectures based on the inputted workflow information, then share 558 these architectures with the simulation processor 554. These initial data center architectures or hardware architectures may be suited, according to the model's analysis, to perform the given workflow based on one or more criteria such as power, latency, cost, and other factors. The simulation processor 554 may simulate the given workflow on these initial architectures in a digital, multi-dimensional space. In these simulations, the simulation processor 554 may collect one or more performance data indicating how each simulated data center architecture or hardware performs the workflow in terms of metrics such as power, latency, cost, and other criteria. If the simulation processor 554 determines that none of the initial architectures satisfy the one or more criteria, then the simulation processor 554 may prompt the refined model 552 to generate updated architectures by sending 560 the performance data gathered by the simulations of the initial architectures and sending 562 one or more user-provided information indicating the user's desired outcomes for the architecture. The user-provided information may include, without limitation, an updated set of criteria, such as an indication the architecture should prioritize costs to a greater degree than previously indicated. In other example embodiments, the user may manipulate virtual objects within the digitally represented simulation of one or more architectures to indicate a desired change to the structural or physical elements of the data center architecture. In still other example embodiments, the user may select a sub-group of the initial architectures and indicate that they want the refined model 552 to update this sub-group of the initial architectures according to new criteria, updated criteria, or other similar requests. In response to receiving the performance data and the user-provided information, the refined model 552 may use these performance data and the user-provided information as inputs to generate one or more updated data center architectures and hardware architectures and share 564 them with the simulation processor 554.

In other example embodiments, the simulation processor 554 may share additional user-provided information any number of times. For example, a user may update their preferences and criteria several times before ultimately selecting a data center architecture. Furthermore, the simulation processor 554 may provide a plurality of workflows if a user desires to run multiple workflows on a data center architecture.

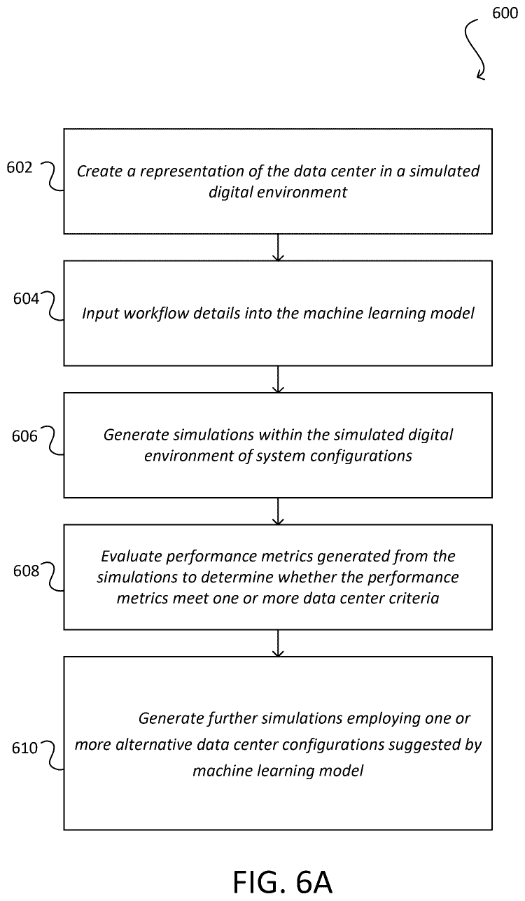

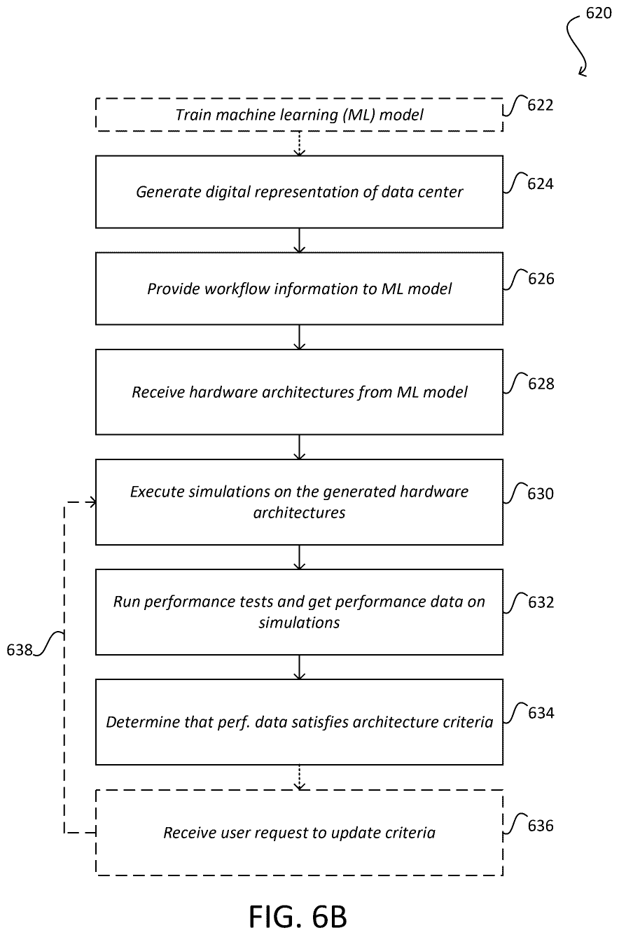

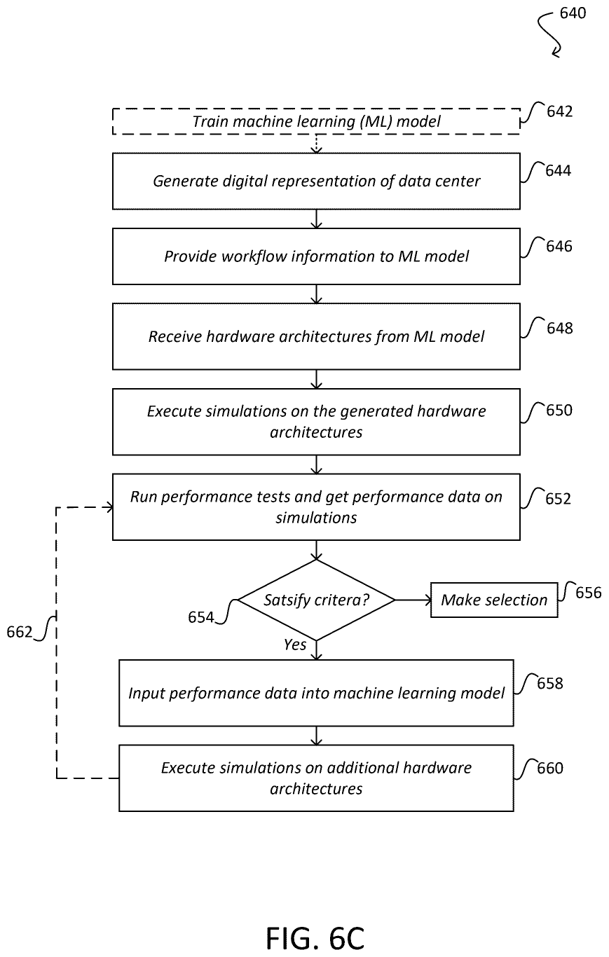

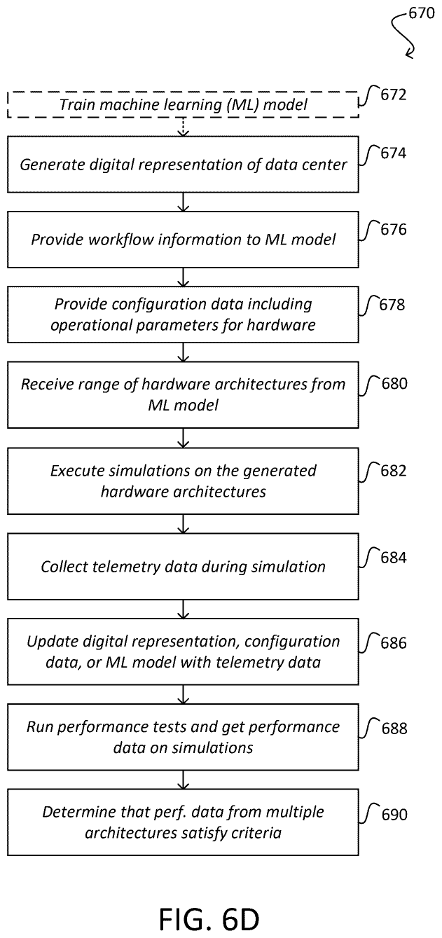

FIG. 6A illustrates a method 600 according to at least one embodiment. Each action in the method 600 may be performed by one or more processors or processing units. Each action in the method 600 may be performed by one or more processors and/or one or more servers. It should be appreciated that steps for the method may be performed in any order, or in parallel, unless otherwise specifically stated. Moreover, the method may include more or fewer steps.

A processor may create 602 a representation of a data center or data center architecture in a simulated digital environment, such as a virtual environment of two or three dimensions. The processor may input 604 one or more workflow details into a machine learning model. The workflow details may include, without limitation, data processing tasks such as batch processing for large datasets, real-time analytics for monitoring and responding to live data streams, and hosting web applications that require high availability and low latency. Additionally, workflows could encompass machine learning model training and inference tasks that demand substantial computational resources, as well as software development environments where continuous integration and deployment processes are executed. Other examples might include backup and recovery operations to ensure data integrity, virtualization workloads that involve running multiple operating systems on shared hardware, and content delivery network (CDN) services aimed at optimizing the distribution of multimedia content across geographically dispersed users. Based on one or more data center architectures and/or hardware architectures generated as outputs from the machine learning model, the processor may generate 606 one or more simulations within the digital environment of the generated data center architectures and/or hardware architectures identified by the machine learning model as being potentially effective for executing the given one or more workflows. The processor may evaluate 608 the performance of the simulated data center architectures by analyzing the performance data gathered during the simulated performance of the workflow by the one or more data center architectures. This evaluation may depend at least in part on whether the performance data meets one or more criteria set by the user. The performance data and associated criteria may include without limitation target cost, power consumption, available space, thermal management, latency, scalability, level of performance, number of processing nodes to be used to perform the workflow, and other considerations.

In at least some example embodiments, the processor may determine that at least one of the simulated data center architectures meets one or more of the criteria, i.e., that one of the data center architectures is a suitable candidate for the workflow.

In other embodiments, however, the process may determine that none of the data center architecture satisfies the criteria. In such embodiments, the processor input the performance data and other related information to the machine learning model, receive additional data center architectures and hardware architectures, and generate 610 further simulations on these data center architectures until the performance data or performance metrics align with the criteria. This step can be iterated one or more times until a data center architecture meets one or more criteria.

FIG. 6B illustrates a method 620 according to at least one embodiment. Each action in the method 620 may be performed by one or more processors or processing units. Each action in the method 620 may be performed by one or more processor and/or one or more servers. It should be appreciated that steps for the method may be performed in any order, or in parallel, unless otherwise specifically stated. Moreover, the method may include more or fewer steps.

A server or processor may train a machine learning model 622 to generate one or more data center architectures. The machine learning model 622 might be trained using a dataset that encompasses various inputs relevant to data center operations and performance. In example embodiments, as inputs, the model would receive workflow information detailing different types of programs, applications, and software that will run on the data center, alongside architectural details of existing data center configurations, including without limitation rack layouts and cooling systems. Additionally, the inputs may incorporate hardware specifications such as server capabilities, storage options, and network infrastructure. Telemetry data from previous data center operations—such as temperature readings, power consumption metrics, and CPU utilization rates—would also serve as critical input features. Furthermore, performance data indicating how various data center architectures performed under specific workflows may be used as inputs. The outputs of the machine learning model 622 would consist of one or more recommended data center or hardware architectures that are predicted to deliver optimal performance for a given workflow based on established criteria like cost efficiency, latency reduction, and effective heat management. Through iterative training processes involving, without limitation, supervised or unsupervised learning techniques and optimization algorithms, the machine learning model 622 may refine its predictions over time to enhance accuracy in recommending configurations tailored to specific operational requirements. Furthermore, one or more steps in the training process may be iterated one or more times.

The processor may generate 624 a digital representation of a data center. The processor may provide 626 workflow information to the machine learning model and receive 628 one or more data center architectures and/or hardware architectures from the model. Based on these received data center architectures and/or hardware architectures, the process may execute 630 simulations on the data center architectures and run 632 performance tests and gather associated performance data on each simulation. In example embodiments, that processor may gather performance data such as cost, power consumption, available space, thermal management, scalability, and other considerations. As the simulations perform the workflow, the processor gathers performance data about each data center architecture and analyzes them, ultimately determining 634 whether any of the performance data on the simulated data center architectures satisfies the criteria.

The processor may receive 636 a user request from a user device over a network to update the criteria. In example embodiments, the user may review the highest performing range of data center architectures but determine that the criteria need to be adjusted. In other example embodiments, the system may provide the user with an interactive visualization that allows for real-time manipulation of the data center's layout and operational efficiency. The user may provide the system via a user device with one or more manipulations, changes, edits, queries, or commands based on an interaction between the user and the interactive visualization. In other example embodiments, the user may transmit a request or message to the simulation processor, to produce one or more new data center architectures or hardware architectures based on an adjustment of cost (e.g., cost reduction), adjust the number of nodes or devices in the architecture, or any other criteria. The processor may iterate 638 the simulation of more data center architectures any number of times until the data center architectures satisfy the criteria and/or the user makes a selection.

FIG. 6C illustrates a method 640 according to at least one embodiment. Each action in the method 640 may be performed by one or more processors or processing units. Each action in the process 500 may be performed by one or more processor and/or one or more servers. It should be appreciated that steps for the method may be performed in any order, or in parallel, unless otherwise specifically stated. Moreover, the method may include more or fewer steps.

A server or processor may train 642 a machine learning model to generate one or more data center architectures as discussed above. The processor may generate 644 a digital representation of a data center. The processor may provide 646 workflow information to the machine learning model and receive 648 one or more data center architectures and/or hardware architectures from the model. Based on these received data center architectures and/or hardware architectures, the process may execute 650 simulations on the data center architectures and run 652 performance tests and gather associated performance data on each simulation. In example embodiments, that processor may gather performance data such as cost, power consumption, available space, thermal management, scalability, and other considerations.

The processor may determine 654 if the performance data from the simulations satisfies one or more criteria. In example embodiments, the processor may determine whether the simulations met a certain cost or power consumption. If the processor determines that one or more of the data center architectures satisfies the criteria, then the processor may make 656 a selection of those data center architectures. If not, then the processor will input 658 the performance data, as well as any other configuration data, updated criteria, or other information into the machine model and receive additional data center architectures and hardware architectures. The processor may execute 660 the simulations on these additional data center architectures and hardware architectures and iterate 662 running performance tests and determining whether any of the additional data center architectures satisfy the criteria.

FIG. 6D illustrates a method 670 according to at least one embodiment. Each action in the method 670 may be performed by one or more processors or processing units. Each action in the method 670 may be performed by one or more processor and/or one or more servers. It should be appreciated that steps for the method may be performed in any order, or in parallel, unless otherwise specifically stated. Moreover, the method may include more or fewer steps.

A server or processor may train 672 a machine learning model to generate one or more data center architectures as discussed above. The processor may generate 674 a digital representation of a data center. The processor may provide 676 workflow information to the machine learning model as described elsewhere herein. The processor may also provide 678 as well as configuration data including any number of operational parameters for data center architectures and/or hardware architectures. These parameters may include without limitation configuration data refers to the specific settings and structural details of the data center architecture that can influence its performance, including without limitation the arrangement of server racks, types of cooling systems employed, network topology, and hardware specifications like CPU types, memory capacity, and storage solutions. Operational parameters may encompass various metrics and thresholds that define how the data center operates under different conditions. These parameters might include power limits for individual servers, temperature setpoints for HVAC systems, workload distribution strategies across servers, and expected traffic patterns for network communications. By feeding this configuration data and operational parameters into the machine learning model, the processor enables it to analyze how different architectural choices impact overall efficiency and performance in real-world scenarios. The processor may retrieve these parameters from a data storage unit. In some example embodiments, the processor receives these parameters from a user device, administrative device, or other device connected to the processor over a wired or wireless network.

Additionally, the processor may also receive 680 a range of hardware architectures from the model. At this point in the method 670, the user may be enabled by the system to select a hardware architecture option within the range. For example, the processor may transmit the range of hardware architectures to a user device associated with the user. The processor may receive one or more selections from the user indicating the user wants to simulate, analyze, or further configure those one or more selections within the range. The user may also indicate that they would like a new and/or different range of hardware architectures. This range of hardware models may include various configurations of server types, such as blade servers, rack-mounted servers, and high-density compute nodes, each optimized for different workloads and performance requirements. It may also encompass specifications for storage solutions, including traditional hard disk drives (HDDs), solid-state drives (SSDs), and hybrid storage systems designed to balance speed and capacity. Furthermore, the models might suggest network infrastructure options like switches and routers that facilitate efficient data flow between components, as well as recommendations for cooling systems that enhance thermal management based on the predicted heat output of the proposed configurations.

The processor may execute 682 simulations on the data center architectures. While the processor runs these simulations, the processor may collect 684 telemetry data including without limitation temperature readings at various locations within the data center, including server racks and HVAC units, to evaluate cooling effectiveness and identify potential hotspots. The simulation processor 402 may also monitor power consumption metrics, such as total kilowatt-hours used by individual servers and cooling systems, allowing for calculations of operational costs over time. Network latency measurements can be recorded to analyze the speed of data transfers between servers, with specific attention to round-trip times for critical applications. Additionally, the simulation processor 402 might collect utilization rates for CPU and memory resources across different configurations to determine how effectively hardware is being employed. Metrics related to resource availability, such as downtime incidents or failure rates of specific components, can also be observed to gauge reliability.

The processor may update 686 the simulations and digital representations, the configuration data, and the machine learning model based on this collected telemetry data. This update is done to enhance the accuracy and relevance of the simulations by incorporating real-time insights into how various data center architectures perform under actual operating conditions. By analyzing telemetry data such as temperature fluctuations, power consumption patterns, and resource utilization metrics, the processor can refine existing models to better reflect current performance trends and operational challenges. This iterative process allows for continuous improvement of the machine learning model's predictions regarding optimal configurations, ensuring that recommendations remain aligned with evolving workload demands and efficiency objectives. The processor may run 688 performance tests and gather associated performance data on each simulation. In example embodiments, that processor may gather performance data such as cost, power consumption, available space, thermal management, scalability, and other considerations.

As the simulations perform the workflow, the processor gathers performance data about each data center architecture and analyzes them, ultimately determining 690 whether any of the performance data on the simulated data center architectures satisfies the criteria. As described elsewhere herein, this process may iterate one or more steps to update the modeling and simulation actions as well as update the criteria according to those set by a user or administrator. Additionally, at this point in the method 670, the user may be enabled by the system to select a hardware architecture option within the range. For example, the processor may transmit the range of hardware architectures that satisfy the criteria to a user device associated with the user. The processor may receive one or more selections from the user indicating the user wants to simulate, analyze, or further configure those one or more selections within the range. The user may also indicate that they would like a new and/or different range of hardware architectures.

### INFERENCE AND TRAINING LOGIC

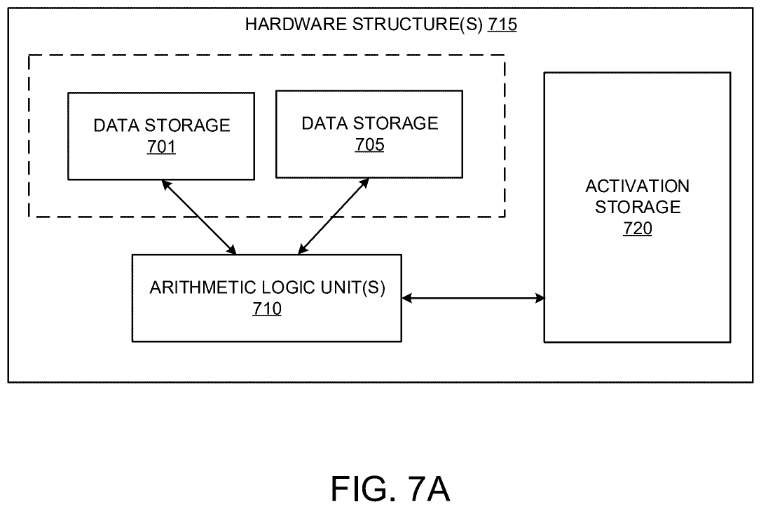

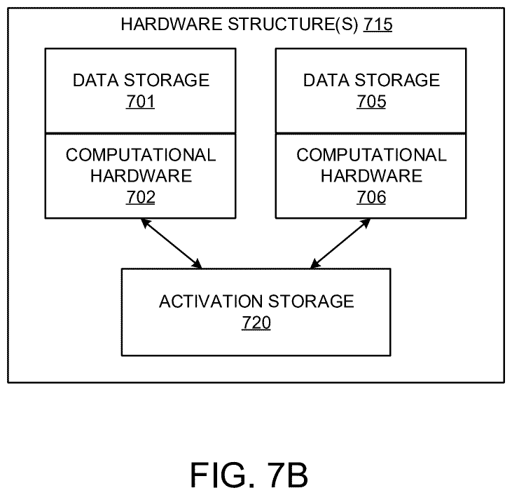

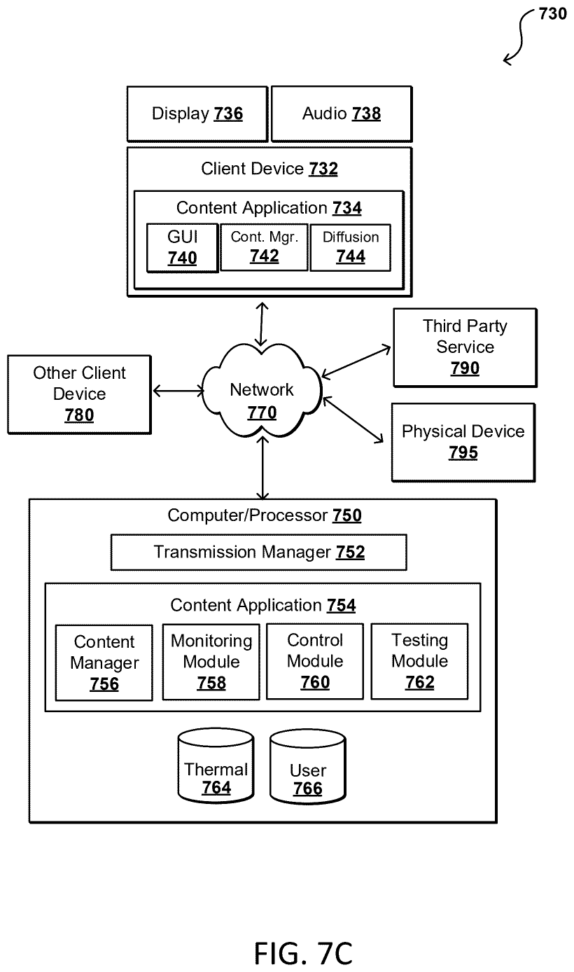

FIG. 7A illustrates inference and/or training logic 715 used to perform inferencing and/or training operations associated with one or more embodiments. Details regarding inference and/or training logic 715 are provided below in conjunction with FIGS. 7A and/or 7B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or data storage 701 may be cache memory, dynamic randomly addressable memory (“DRAM”), static randomly addressable memory (“SRAM”), non-volatile memory (e.g., Flash memory), or other storage. In at least one embodiment, choice of whether code and/or data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to on one or more processors or other hardware logic devices or circuits. In at least one embodiment, code and/or data storage 705 may be cache memory, DRAM, SRAM, non-volatile memory (e.g., Flash memory), or other storage. In at least one embodiment, choice of whether code and/or data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be same storage structure. In at least one embodiment, code and/or data storage 701 and code and/or data storage 705 may be partially same storage structure and partially separate storage structures. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or code and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one or more embodiments. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one “storage/computational pair 701/702” of code and/or data storage 701 and computational hardware 702 is provided as an input to “storage/computational pair 705/706” of code and/or data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

As discussed, aspects of various approaches presented herein can be lightweight enough to execute on a device such as a client device, such as a personal computer or gaming console, in real time. Such processing can be performed on, or for, content that is generated on, or received by, that client device or received from an external source, such as streaming data or other content received over at least one network. In some instances, the processing and/or determination of this content may be performed by one of these other devices, systems, or entities, then provided to the client device (or another such recipient) for presentation or another such use.

FIG. 7C illustrates an example network configuration 730 of components that can be used to implement aspects of various embodiments, such as to provide, generate, modify, encode, process, fuse, and/or transmit generated image data, calculated measurements, or other such content. In at least one embodiment, a client device 732 can generate or receive data for a session using components of a content application 734 on the client device 732 and data stored locally on that client device. In at least one embodiment, a content application 754 executing on a computer or processor 750 (e.g., a cloud server or control system) may initiate a session associated with at least one client device 732 (e.g., a vehicle or robot), as may use a session manager and user data stored in a user database 766, and can cause content such as liquid coolant or server thermal data to be selected and/or retrieved from a repository 764 to be used by a testing module 762 to calculate one or more performance metrics for a monitoring module 758, which can provide flow data or thermal data to a control module 760 to control a flow or temperature, in an environment where the data is to be used to determine appropriate operation. A content manager 756 may work with at least these various modules to perform testing and analysis, and potentially instruct any actions to be taken in response to a performance metric failing to satisfy an operational requirements. At least a portion of this data or instructional content can be transmitted to the client device 732 and/or a physical device 795 using an appropriate transmission manager 752 to send by download, streaming, or another such transmission channel. An encoder may be used to encode and/or compress at least some of this data before transmitting to the client device 732. In at least one embodiment, the client device 732 receiving such content can provide this content to a corresponding content application 734, which may also or alternatively include a graphical user interface 740, a flow monitor module 742, and a control module 744 for use in providing, synthesizing, rendering, compositing, modifying, or using content for presentation, navigation, control, (or other purposes) on or by the client device 732, such as may be transmitted to the physical device 795. In some embodiments, the computer or processor 750 and client device 732 may be able to communicate directly without needing to transmit data over a network 770, in order to avoid issues with latency and availability, etc. A decoder may also be used to decode data received over the network 770 for presentation via client device 732, such as imaging content or performance metrics through a display device 736 and audio, such as corresponding sounds or synthesized speech, through at least one audio playback device 738, such as speakers or headphones. In at least one embodiment, at least some of this content may already be stored on, rendered on, or accessible to client device 732 such that transmission over a network 770 is not required for at least that portion of content, such as where that content (e.g., thermal data) may have been previously downloaded or stored locally on a hard drive or optical disk. In at least one embodiment, a transmission mechanism such as data streaming can be used to transfer this content from the computer or processor 750, or user database 766, to the client device 732. In at least one embodiment, at least a portion of this content can be obtained, enhanced, and/or streamed from another source, such as a third party service 790 or other client device 780, that may also include a content application for generating, updating, enhancing, or providing map content. In at least one embodiment, portions of this functionality can be performed using multiple computing devices, or multiple processors within one or more computing devices, such as may include a combination of CPUs and GPUs (Graphics Processing Unit), (DPUs), (QPUs), a plurality of parallel processing units (PPUs).

In this example, these client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, which sits on a network edge and is outside at least one security layer associated with the cloud provider environment. In this way, latency can be reduced by enabling the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device, or may incorporate one or more Virtual Machines (VMs). In at least one embodiment, such a system can be implemented at least partially in a data center or at least partially using cloud computing resources.

### DATA CENTER

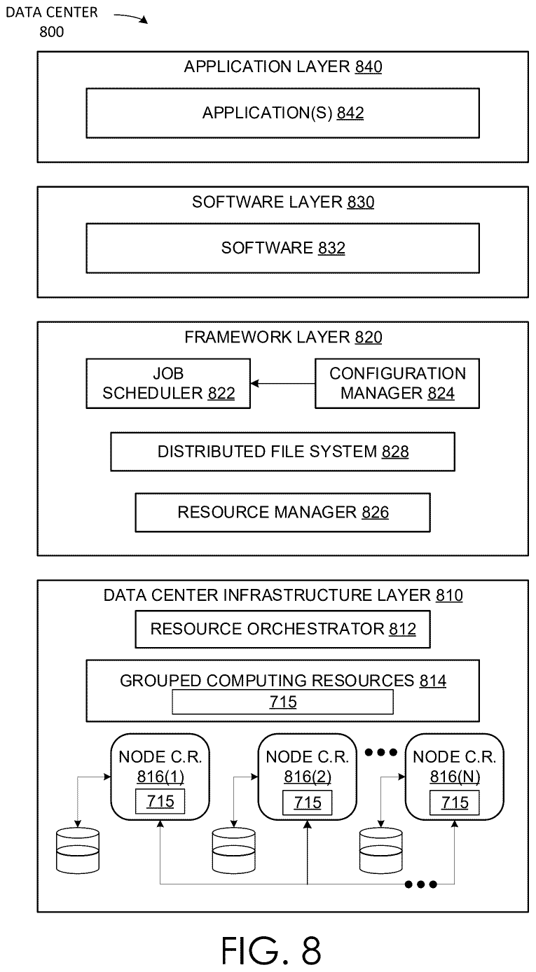

FIG. 8 illustrates an example data center 800, in which at least one embodiment may be used. In at least one embodiment, data center 800 includes a data center infrastructure layer 810, a framework layer 820, a software layer 830, and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator 812 may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may use distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resource 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. The one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underused and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components can be used for data center architecture generation and analysis.

### COMPUTER SYSTEMS

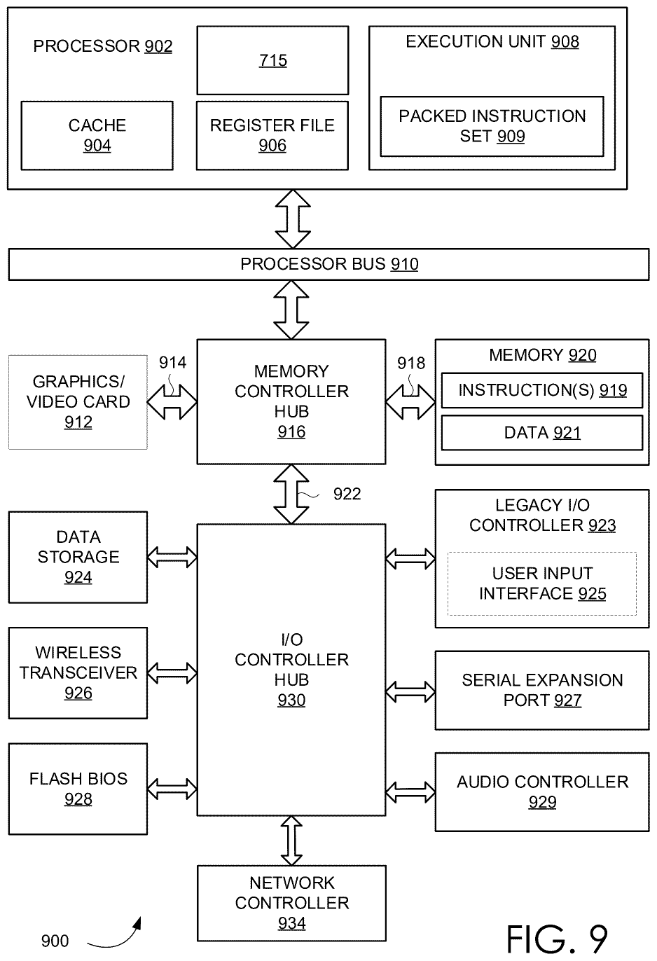

FIG. 9 is a block diagram illustrating an exemplary computer system, which may be a system with interconnected devices and components, a system-on-a-chip (SOC) or some combination thereof 900 formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment computer system 900 may be a multiprocessor system. In at least one embodiment, processor 902 may include, without limitation, a complex instruction set computing (“CISC”) microprocessor, a reduced instruction set computing (“RISC”) microprocessor, a very long instruction word (“VLIW”) computing microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs. In at least one embodiment, register file 906 may store different types of data in various registers including, without limitation, integer registers, floating point registers, status registers, and instruction pointer register.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interfaces 925, a serial expansion port 927, such as Universal Serial Bus (“USB”), and a network controller 934. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components can be used for data center architecture generation and analysis.

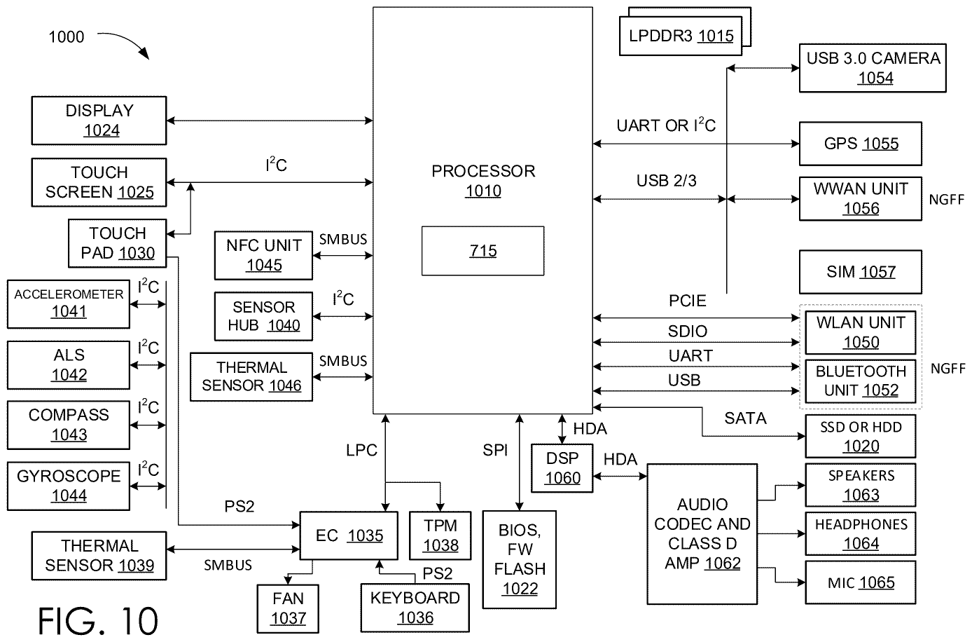

FIG. 10 is a block diagram illustrating an electronic device 1000 for utilizing a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 1000 may include, without limitation, processor 1010 communicatively coupled to any suitable number or kind of components, peripherals, modules, or devices. In at least one embodiment, processor 1010 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 10 illustrates a system, which includes interconnected hardware devices or “chips”, whereas in other embodiments, FIG. 10 may illustrate an exemplary System on a Chip (“SoC”). In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1036, and a touch pad 1030 may be communicatively coupled to EC 1035. In at least one embodiment, speakers 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1062 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 10 for inferencing or predicting operations based, at least in part, on weight parameters calculated using neural network training operations, neural network functions and/or architectures, or neural network use cases described herein.

Such components can be used for data center architecture generation and analysis.

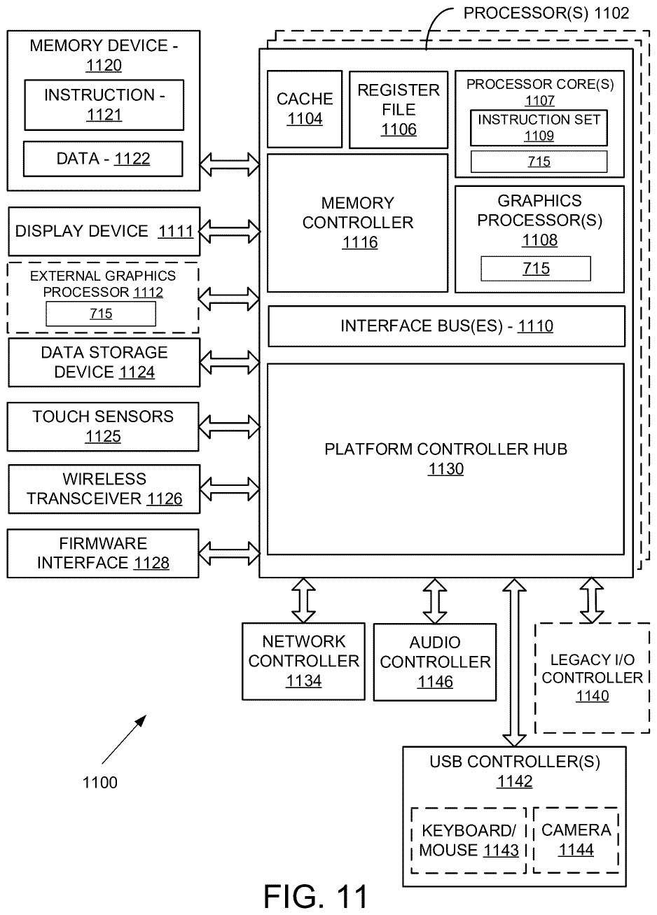

FIG. 11 is a block diagram of a processing system, according to at least one embodiment. In at least one embodiment, system 1100 includes one or more processor(s) 1102 and one or more graphics processor(s) 1108, and may be a single processor desktop system, a multiprocessor workstation system, or a server system having a large number of processor(s) 1102 or processor core(s) 1107. In at least one embodiment, system 1100 is a processing platform incorporated within a system-on-a-chip (SoC) integrated circuit for use in mobile, handheld, or embedded devices.

In at least one embodiment, system 1100 can include, or be incorporated within a server-based gaming platform, a game console, including a game and media console, a mobile gaming console, a handheld game console, or an online game console. In at least one embodiment, system 1100 is a mobile phone, smart phone, tablet computing device or mobile Internet device. In at least one embodiment, processing system 1100 can also include, coupled with, or be integrated within a wearable device, such as a smart watch wearable device, smart eyewear device, augmented reality device, or virtual reality device. In at least one embodiment, processing system 1100 is a television or set top box device having one or more processor(s) 1102 and a graphical interface generated by one or more graphics processor(s) 1108.

In at least one embodiment, one or more processor(s) 1102 each include one or more processor core(s) 1107 to process instructions which, when executed, perform operations for system and user software. In at least one embodiment, each of one or more processor core(s) 1107 is configured to process a specific instruction set 1109. In at least one embodiment, instruction set 1109 may facilitate Complex Instruction Set Computing (CISC), Reduced Instruction Set Computing (RISC), or computing via a Very Long Instruction Word (VLIW). In at least one embodiment, processor core(s) 1107 may each process a different instruction set 1109, which may include instructions to facilitate emulation of other instruction sets. In at least one embodiment, processor core(s) 1107 may also include other processing devices, such a Digital Signal Processor (DSP).

In at least one embodiment, processor(s) 1102 includes cache memory 1104. In at least one embodiment, processor(s) 1102 can have a single internal cache or multiple levels of internal cache. In at least one embodiment, cache memory is shared among various components of processor(s) 1102. In at least one embodiment, processor(s) 1102 also uses an external cache (e.g., a Level-3 (L3) cache or Last Level Cache (LLC)) (not shown), which may be shared among processor core(s) 1107 using known cache coherency techniques. In at least one embodiment, register file 1106 is additionally included in processor(s) 1102 which may include different types of registers for storing different types of data (e.g., integer registers, floating point registers, status registers, and an instruction pointer register). In at least one embodiment, register file 1106 may include general-purpose registers or other registers.

In at least one embodiment, one or more processor(s) 1102 are coupled with one or more interface bus(es) 1110 to transmit communication signals such as address, data, or control signals between processor(s) 1102 and other components in system 1100. In at least one embodiment, interface bus(es) 1110, in one embodiment, can be a processor bus, such as a version of a Direct Media Interface (DMI) bus. In at least one embodiment, interface bus(es) 1110 is not limited to a DMI bus, and may include one or more Peripheral Component Interconnect buses (e.g., PCI, PCI Express), memory busses, or other types of interface busses. In at least one embodiment processor(s) 1102 include an integrated memory controller 1116 and a platform controller hub 1130. In at least one embodiment, memory controller 1116 facilitates communication between a memory device and other components of system 1100, while platform controller hub (PCH) 1130 provides connections to I/O devices via a local I/O bus.

In at least one embodiment, memory device 1120 can be a dynamic random access memory (DRAM) device, a static random access memory (SRAM) device, flash memory device, phase-change memory device, or some other memory device having suitable performance to serve as process memory. In at least one embodiment memory device 1120 can operate as system memory for system 1100, to store data 1122 and instruction 1121 for use when one or more processor(s) 1102 executes an application or process. In at least one embodiment, memory controller 1116 also couples with an optional external graphics processor 1112, which may communicate with one or more graphics processor(s) 1108 in processor(s) 1102 to perform graphics and media operations. In at least one embodiment, a display device 1111 can connect to processor(s) 1102. In at least one embodiment display device 1111 can include one or more of an internal display device, as in a mobile electronic device or a laptop device or an external display device attached via a display interface (e.g., DisplayPort, etc.). In at least one embodiment, display device 1111 can include a head mounted display (HMD) such as a stereoscopic display device for use in virtual reality (VR) applications or augmented reality (AR) applications.

In at least one embodiment, platform controller hub 1130 enables peripherals to connect to memory device 1120 and processor(s) 1102 via a high-speed I/O bus. In at least one embodiment, I/O peripherals include, but are not limited to, an audio controller 1146, a network controller 1134, a firmware interface 1128, a wireless transceiver 1126, touch sensors 1125, a data storage device 1124 (e.g., hard disk drive, flash memory, etc.). In at least one embodiment, data storage device 1124 can connect via a storage interface (e.g., SATA) or via a peripheral bus, such as a Peripheral Component Interconnect bus (e.g., PCI, PCI Express). In at least one embodiment, touch sensors 1125 can include touch screen sensors, pressure sensors, or fingerprint sensors. In at least one embodiment, wireless transceiver 1126 can be a Wi-Fi transceiver, a Bluetooth transceiver, or a mobile network transceiver such as a 3G, 4G, or Long Term Evolution (LTE) transceiver. In at least one embodiment, firmware interface 1128 enables communication with system firmware, and can be, for example, a unified extensible firmware interface (UEFI). In at least one embodiment, network controller 1134 can enable a network connection to a wired network. In at least one embodiment, a high-performance network controller (not shown) couples with interface bus(es) 1110. In at least one embodiment, audio controller 1146 is a multi-channel high definition audio controller. In at least one embodiment, system 1100 includes an optional legacy I/O controller 1140 for coupling legacy (e.g., Personal System 2 (PS/2)) devices to system. In at least one embodiment, platform controller hub 1130 can also connect to one or more Universal Serial Bus (USB) controller(s) 1142 connect input devices, such as keyboard and mouse 1143 combinations, a camera 1144, or other USB input devices.

In at least one embodiment, an instance of memory controller 1116 and platform controller hub 1130 may be integrated into a discreet external graphics processor, such as external graphics processor 1112. In at least one embodiment, platform controller hub 1130 and/or memory controller 1116 may be external to one or more processor(s) 1102. For example, in at least one embodiment, system 1100 can include an external memory controller 1116 and platform controller hub 1130, which may be configured as a memory controller hub and peripheral controller hub within a system chipset that is in communication with processor(s) 1102.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into graphics processor 1500. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can be used for data center architecture generation and analysis.

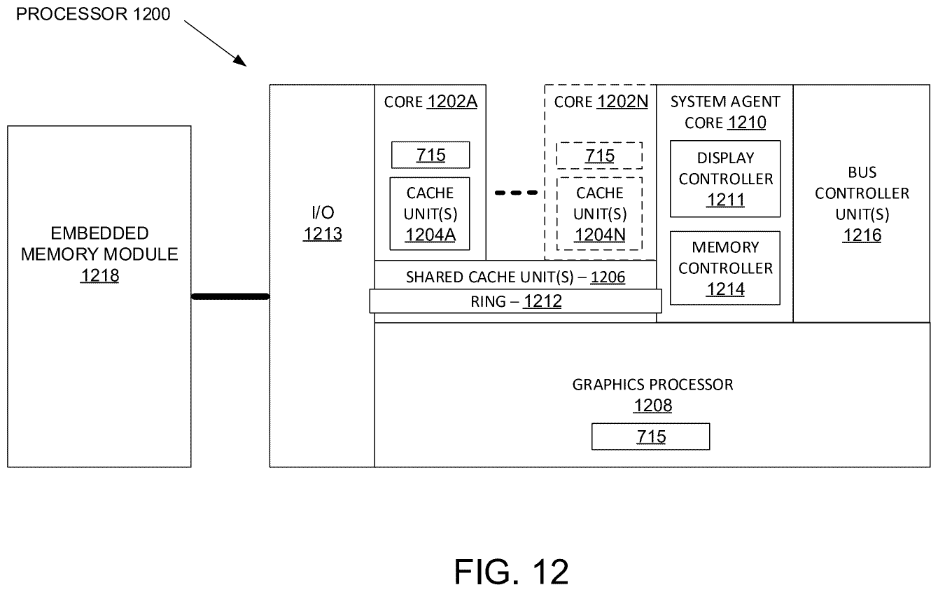

FIG. 12 is a block diagram of a processor 1200 having one or more processor core(s) 1202A-1202N, an integrated memory controller 1214, and an integrated graphics processor 1208, according to at least one embodiment. In at least one embodiment, processor 1200 can include additional cores up to and including additional core 1202N represented by dashed lined boxes. In at least one embodiment, each of processor core(s) 1202A-1202N includes one or more internal cache unit(s) 1204A-1204N. In at least one embodiment, each processor core also has access to one or more shared cached unit(s) 1206.

In at least one embodiment, internal cache unit(s) 1204A-1204N and shared cache unit(s) 1206 represent a cache memory hierarchy within processor 1200. In at least one embodiment, cache unit(s) 1204A-1204N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache unit(s) 1206 and 1204A-1204N.

In at least one embodiment, processor 1200 may also include a set of one or more bus controller unit(s) 1216 and a system agent core 1210. In at least one embodiment, one or more bus controller unit(s) 1216 manage a set of peripheral buses, such as one or more PCI or PCI express busses. In at least one embodiment, system agent core 1210 provides management functionality for various processor components. In at least one embodiment, system agent core 1210 includes one or more integrated memory controllers 1214 to manage access to various external memory devices (not shown).

In at least one embodiment, one or more of processor core(s) 1202A-1202N include support for simultaneous multi-threading. In at least one embodiment, system agent core 1210 includes components for coordinating and processor core(s) 1202A-1202N during multi-threaded processing. In at least one embodiment, system agent core 1210 may additionally include a power control unit (PCU), which includes logic and components to regulate one or more power states of processor core(s) 1202A-1202N and graphics processor 1208.

In at least one embodiment, processor 1200 additionally includes graphics processor 1208 to execute graphics processing operations. In at least one embodiment, graphics processor 1208 couples with shared cache unit(s) 1206, and system agent core 1210, including one or more integrated memory controllers 1214. In at least one embodiment, system agent core 1210 also includes a display controller 1211 to drive graphics processor output to one or more coupled displays. In at least one embodiment, display controller 1211 may also be a separate module coupled with graphics processor 1208 via at least one interconnect, or may be integrated within graphics processor 1208.

In at least one embodiment, a ring based interconnect unit 1212 is used to couple internal components of processor 1200. In at least one embodiment, an alternative interconnect unit may be used, such as a point-to-point interconnect, a switched interconnect, or other techniques. In at least one embodiment, graphics processor 1208 couples with a ring based interconnect unit 1212 via an I/O link 1213.

In at least one embodiment, I/O link 1213 represents at least one of multiple varieties of I/O interconnects, including an on package I/O interconnect which facilitates communication between various processor components and a high-performance embedded memory module 1218, such as an eDRAM module. In at least one embodiment, each of processor core(s) 1202A-1202N and graphics processor 1208 use embedded memory modules 1218 as a shared Last Level Cache.

In at least one embodiment, processor core(s) 1202A-1202N are homogenous cores executing a common instruction set architecture. In at least one embodiment, processor core(s) 1202A-1202N are heterogeneous in terms of instruction set architecture (ISA), where one or more of processor core(s) 1202A-1202N execute a common instruction set, while one or more other cores of processor core(s) 1202A-1202N executes a subset of a common instruction set or a different instruction set. In at least one embodiment, processor core(s) 1202A-1202N are heterogeneous in terms of microarchitecture, where one or more cores having a relatively higher power consumption couple with one or more power cores having a lower power consumption. In at least one embodiment, processor 1200 can be implemented on one or more chips or as an SoC integrated circuit.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into processor 1200. For example, in at least one embodiment, training and/or inferencing techniques described herein may use one or more of ALUs embodied in graphics processor 1208, graphics core(s) 1202A-1202N, or other components in FIG. 12. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of graphics processor 1200 to perform one or more machine learning algorithms, neural network architectures, use cases, or training techniques described herein.

Such components can be used for data center architecture generation and analysis.

### VIRTUALIZED COMPUTING PLATFORM

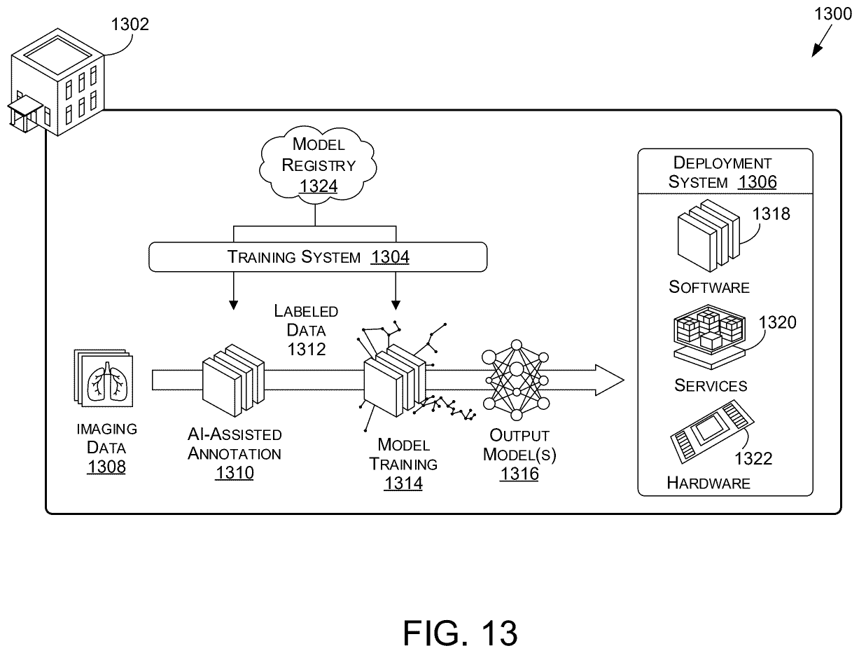

FIG. 13 is an example data flow diagram for a process 1300 of generating and deploying an image processing and inferencing pipeline, in accordance with at least one embodiment. In at least one embodiment, process 1300 may be deployed for use with imaging devices, processing devices, and/or other device types at one or more facilities 1302. Process 1300 may be executed within a training system 1304 and/or a deployment system 1306. In at least one embodiment, training system 1304 may be used to perform training, deployment, and implementation of machine learning models (e.g., neural networks, object detection algorithms, computer vision algorithms, etc.) for use in deployment system 1306. In at least one embodiment, deployment system 1306 may be configured to offload processing and compute resources among a distributed computing environment to reduce infrastructure requirements at facility 1302. In at least one embodiment, one or more applications in a pipeline may use or call upon services (e.g., inference, visualization, compute, AI, etc.) of deployment system 1306 during execution of applications.

In at least one embodiment, some of applications used in advanced processing and inferencing pipelines may use machine learning models or other AI to perform one or more processing steps. In at least one embodiment, machine learning models may be trained at facility 1302 using data 1308 (such as imaging data) generated at facility 1302 (and stored on one or more picture archiving and communication system (PACS) servers at facility 1302), may be trained using imaging or sequencing data 1308 from another facility(ies), or a combination thereof. In at least one embodiment, training system 1304 may be used to provide applications, services, and/or other resources for generating working, deployable machine learning models for deployment system 1306.

In at least one embodiment, model registry 1324 may be backed by object storage that may support versioning and object metadata. In at least one embodiment, object storage may be accessible through, for example, a cloud storage compatible application programming interface (API) from within a cloud platform. In at least one embodiment, machine learning models within model registry 1324 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training system 1304 (FIG. 13) may include a scenario where facility 1302 is training their own machine learning model, or has an existing machine learning model that needs to be optimized or updated. In at least one embodiment, imaging data 1308 generated by imaging device(s), sequencing devices, and/or other device types may be received. In at least one embodiment, once imaging data 1308 is received, AI-assisted annotation 1310 may be used to aid in generating annotations corresponding to imaging data 1308 to be used as ground truth data for a machine learning model. In at least one embodiment, AI-assisted annotation 1310 may include one or more machine learning models (e.g., convolutional neural networks (CNNs)) that may be trained to generate annotations corresponding to certain types of imaging data 1308 (e.g., from certain devices). In at least one embodiment, AI-assisted annotation 1310 may then be used directly, or may be adjusted or fine-tuned using an annotation tool to generate ground truth data. In at least one embodiment, AI-assisted annotation 1310, labeled data 1312, or a combination thereof may be used as ground truth data for training a machine learning model. In at least one embodiment, a trained machine learning model may be referred to as output model(s) 1316, and may be used by deployment system 1306, as described herein.

In at least one embodiment, a training pipeline may include a scenario where facility 1302 needs a machine learning model for use in performing one or more processing tasks for one or more applications in deployment system 1306, but facility 1302 may not currently have such a machine learning model (or may not have a model that is optimized, efficient, or effective for such purposes). In at least one embodiment, an existing machine learning model may be selected from a model registry 1324. In at least one embodiment, model registry 1324 may include machine learning models trained to perform a variety of different inference tasks on imaging data. In at least one embodiment, machine learning models in model registry 1324 may have been trained on imaging data from different facilities than facilities 1302 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1324. In at least one embodiment, a machine learning model may then be retrained, or updated, at any number of other facilities, and a retrained or updated model may be made available in model registry 1324. In at least one embodiment, a machine learning model may then be selected from model registry 1324—and referred to as output model(s) 1316—and may be used in deployment system 1306 to perform one or more processing tasks for one or more applications of a deployment system.

In at least one embodiment, a scenario may include facility 1302 requiring a machine learning model for use in performing one or more processing tasks for one or more applications in deployment system 1306, but facility 1302 may not currently have such a machine learning model (or may not have a model that is optimized, efficient, or effective for such purposes). In at least one embodiment, a machine learning model selected from model registry 1324 may not be fine-tuned or optimized for imaging data 1308 generated at facility 1302 because of differences in populations, robustness of training data used to train a machine learning model, diversity in anomalies of training data, and/or other issues with training data. In at least one embodiment, AI-assisted annotation 1310 may be used to aid in generating annotations corresponding to imaging data 1308 to be used as ground truth data for retraining or updating a machine learning model. In at least one embodiment, labeled data 1312 may be used as ground truth data for training a machine learning model. In at least one embodiment, retraining or updating a machine learning model may be referred to as model training 1314. In at least one embodiment, model training 1314—e.g., AI-assisted annotation 1310, labeled data 1312, or a combination thereof—may be used as ground truth data for retraining or updating a machine learning model. In at least one embodiment, a trained machine learning model may be referred to as output model(s) 1316, and may be used by deployment system 1306, as described herein.

In at least one embodiment, deployment system 1306 may include software 1318, services 1320, hardware 1322, and/or other components, features, and functionality. In at least one embodiment, deployment system 1306 may include a software “stack,” such that software 1318 may be built on top of services 1320 and may use services 1320 to perform some or all of processing tasks, and services 1320 and software 1318 may be built on top of hardware 1322 and use hardware 1322 to execute processing, storage, and/or other compute tasks of deployment system 1306. In at least one embodiment, software 1318 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1308, in addition to containers that receive and configure imaging data for use by each container and/or for use by facility 1302 after processing through a pipeline (e.g., to convert outputs back to a usable data type). In at least one embodiment, a combination of containers within software 1318 (e.g., that make up a pipeline) may be referred to as a virtual instrument (as described in more detail herein), and a virtual instrument may leverage services 1320 and hardware 1322 to execute some or all processing tasks of applications instantiated in containers.

In at least one embodiment, a data processing pipeline may receive input data (e.g., imaging data 1308) in a specific format in response to an inference request (e.g., a request from a user of deployment system 1306). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 1316 of training system 1304.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1324 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1320 as a system (e.g., system 1200 of FIG. 12). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by system 1300 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., system 1300 of FIG. 13). In at least one embodiment, completed and validated applications or containers may be stored in a container registry and associated machine learning models may be stored in model registry 1324. In at least one embodiment, a requesting entity—who provides an inference or image processing request—may browse a container registry and/or model registry 1324 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1306 (e.g., a cloud) to perform processing of data processing pipeline. In at least one embodiment, processing by deployment system 1306 may include referencing selected elements (e.g., applications, containers, models, etc.) from a container registry and/or model registry 1324. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1320 may be leveraged. In at least one embodiment, services 1320 may include compute services, artificial intelligence (AI) services, visualization services, and/or other service types. In at least one embodiment, services 1320 may provide functionality that is common to one or more applications in software 1318, so functionality may be abstracted to a service that may be called upon or leveraged by applications. In at least one embodiment, functionality provided by services 1320 may run dynamically and more efficiently, while also scaling well by allowing applications to process data in parallel (e.g., using a parallel computing platform 1230 (FIG. 12)). In at least one embodiment, rather than each application that shares a same functionality offered by services 1320 being required to have a respective instance of services 1320, services 1320 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects—such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where services 1320 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1318 implementing advanced processing and inferencing pipeline that includes segmentation application and anomaly detection application may be streamlined because each application may call upon a same inference service to perform one or more inferencing tasks.

In at least one embodiment, hardware 1322 may include GPUs, CPUs, graphics cards, an AI/deep learning system (e.g., an AI supercomputer, such as NVIDIA's DGX), a cloud platform, or a combination thereof. In at least one embodiment, different types of hardware 1322 may be used to provide efficient, purpose-built support for software 1318 and services 1320 in deployment system 1306. In at least one embodiment, use of GPU processing may be implemented for processing locally (e.g., at facility 1302), within an AI/deep learning system, in a cloud system, and/or in other processing components of deployment system 1306 to improve efficiency, accuracy, and efficacy of image processing and generation. In at least one embodiment, software 1318 and/or services 1320 may be optimized for GPU processing with respect to deep learning, machine learning, and/or high-performance computing, as non-limiting examples. In at least one embodiment, at least some of computing environment of deployment system 1306 and/or training system 1304 may be executed in a datacenter one or more supercomputers or high performance computing systems, with GPU optimized software (e.g., hardware and software combination of NVIDIA's DGX System). In at least one embodiment, hardware 1322 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

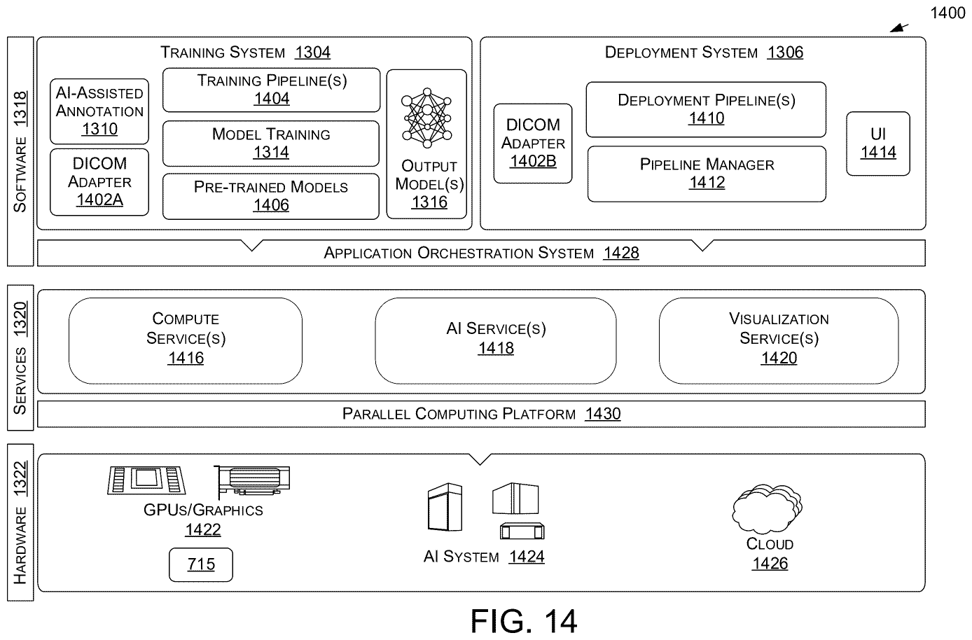

FIG. 14 is a system diagram for an example system 1400 for generating and deploying an imaging deployment pipeline, in accordance with at least one embodiment. In at least one embodiment, system 1400 may be used to implement process 1300 of FIG. 13 and/or other processes including advanced processing and inferencing pipelines. In at least one embodiment, system 1400 may include training system 1304 and deployment system 1306. In at least one embodiment, training system 1304 and deployment system 1306 may be implemented using software 1318, services 1320, and/or hardware 1322, as described herein.

In at least one embodiment, system 1400 (e.g., training system 1304 and/or deployment system 1306) may implemented in a cloud computing environment (e.g., using cloud 1426). In at least one embodiment, system 1400 may be implemented locally with respect to a healthcare services facility, or as a combination of both cloud and local computing resources. In at least one embodiment, access to APIs in cloud 1426 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1400, may be restricted to a set of public IPs that have been vetted or authorized for interaction.

In at least one embodiment, various components of system 1400 may communicate between and among one another using any of a variety of different network types, including but not limited to local area networks (LANs) and/or wide area networks (WANs) via wired and/or wireless communication protocols. In at least one embodiment, communication between facilities and components of system 1400 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1304 may execute training pipelines 1404, similar to those described herein with respect to FIG. 13. In at least one embodiment, where one or more machine learning models are to be used in deployment pipeline(s) 1410 by deployment system 1306, training pipelines 1404 may be used to train or retrain one or more (e.g. pre-trained) models, and/or implement one or more of pre-trained models 1406 (e.g., without a need for retraining or updating). In at least one embodiment, as a result of training pipelines 1404, output model(s) 1316 may be generated. In at least one embodiment, training pipelines 1404 may include any number of processing steps, such as but not limited to imaging data (or other input data) conversion or adaption In at least one embodiment, for different machine learning models used by deployment system 1306, different training pipelines 1404 may be used. In at least one embodiment, training pipeline 1404 similar to a first example described with respect to FIG. 13 may be used for a first machine learning model, training pipeline 1404 similar to a second example described with respect to FIG. 13 may be used for a second machine learning model, and training pipeline 1404 similar to a third example described with respect to FIG. 13 may be used for a third machine learning model. In at least one embodiment, any combination of tasks within training system 1304 may be used depending on what is required for each respective machine learning model. In at least one embodiment, one or more of machine learning models may already be trained and ready for deployment so machine learning models may not undergo any processing by training system 1304, and may be implemented by deployment system 1306.

In at least one embodiment, output model(s) 1316 and/or pre-trained models 1406 may include any types of machine learning models depending on implementation or embodiment. In at least one embodiment, and without limitation, machine learning models used by system 1400 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

In at least one embodiment, training pipelines 1404 may include AI-assisted annotation, as described in more detail herein with respect to at least FIG. 14B. In at least one embodiment, labeled data 1312 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1308 (or other data type used by machine learning models), there may be corresponding ground truth data generated by training system 1304. In at least one embodiment, AI-assisted annotation may be performed as part of deployment pipeline(s) 1410; either in addition to, or in lieu of AI-assisted annotation included in training pipelines 1404. In at least one embodiment, system 1400 may include a multi-layer platform that may include a software layer (e.g., software 1318) of diagnostic applications (or other application types) that may perform one or more medical imaging and diagnostic functions. In at least one embodiment, system 1400 may be communicatively coupled to (e.g., via encrypted links) PACS server networks of one or more facilities. In at least one embodiment, system 1400 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility 1302). In at least one embodiment, applications may then call or execute one or more services 1320 for performing compute, AI, or visualization tasks associated with respective applications, and software 1318 and/or services 1320 may leverage hardware 1322 to perform processing tasks in an effective and efficient manner. In at least one embodiment, communications sent to, or received by, a training system 1304 and a deployment system 1306 may occur using a pair of DICOM adapters 1402A, 1402B.

In at least one embodiment, deployment system 1306 may execute deployment pipeline(s) 1410. In at least one embodiment, deployment pipeline(s) 1410 may include any number of applications that may be sequentially, non-sequentially, or otherwise applied to imaging data (and/or other data types) generated by imaging devices, sequencing devices, genomics devices, etc.-including AI-assisted annotation, as described above. In at least one embodiment, as described herein, a deployment pipeline(s) 1410 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline(s) 1410 depending on information desired from data generated by a device. In at least one embodiment, where detections of anomalies are desired from an MRI machine, there may be a first deployment pipeline(s) 1410, and where image enhancement is desired from output of an MRI machine, there may be a second deployment pipeline(s) 1410.

In at least one embodiment, an image generation application may include a processing task that includes use of a machine learning model. In at least one embodiment, a user may desire to use their own machine learning model, or to select a machine learning model from model registry 1324. In at least one embodiment, a user may implement their own machine learning model or select a machine learning model for inclusion in an application for performing a processing task. In at least one embodiment, applications may be selectable and customizable, and by defining constructs of applications, deployment and implementation of applications for a particular user are presented as a more seamless user experience. In at least one embodiment, by leveraging other features of system 1400—such as services 1320 and hardware 1322—deployment pipeline(s) 1410 may be even more user friendly, provide for easier integration, and produce more accurate, efficient, and timely results.

In at least one embodiment, deployment system 1306 may include a user interface (“UI”) 1414 (e.g., a graphical user interface, a web interface, etc.) that may be used to select applications for inclusion in deployment pipeline(s) 1410, arrange applications, modify or change applications or parameters or constructs thereof, use and interact with deployment pipeline(s) 1410 during set-up and/or deployment, and/or to otherwise interact with deployment system 1306. In at least one embodiment, although not illustrated with respect to training system 1304, UI 1414 (or a different user interface) may be used for selecting models for use in deployment system 1306, for selecting models for training, or retraining, in training system 1304, and/or for otherwise interacting with training system 1304.

In at least one embodiment, pipeline manager 1412 may be used, in addition to an application orchestration system 1428, to manage interaction between applications or containers of deployment pipeline(s) 1410 and services 1320 and/or hardware 1322. In at least one embodiment, pipeline manager 1412 may be configured to facilitate interactions from application to application, from application to services 1320, and/or from application or service to hardware 1322. In at least one embodiment, although illustrated as included in software 1318, this is not intended to be limiting, and in some examples pipeline manager 1412 may be included in services 1320. In at least one embodiment, application orchestration system 1428 (e.g., Kubernetes, DOCKER, etc.) may include a container orchestration system that may group applications into containers as logical units for coordination, management, scaling, and deployment. In at least one embodiment, by associating applications from deployment pipeline(s) 1410 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1412 and application orchestration system 1428. In at least one embodiment, so long as an expected input and/or output of each container or application is known by a system (e.g., based on constructs of applications or containers), application orchestration system 1428 and/or pipeline manager 1412 may facilitate communication among and between, and sharing of resources among and between, each of applications or containers. In at least one embodiment, because one or more of applications or containers in deployment pipeline(s) 1410 may share same services and resources, application orchestration system 1428 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1428) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1320 leveraged by and shared by applications or containers in deployment system 1306 may include compute service(s) 1416, AI service(s) 1418, visualization service(s) 1420, and/or other service types. In at least one embodiment, applications may call (e.g., execute) one or more of services 1320 to perform processing operations for an application. In at least one embodiment, compute service(s) 1416 may be leveraged by applications to perform super-computing or other high-performance computing (HPC) tasks. In at least one embodiment, compute service(s) 1416 may be leveraged to perform parallel processing (e.g., using a parallel computing platform 1430) for processing data through one or more of applications and/or one or more tasks of a single application, substantially simultaneously. In at least one embodiment, parallel computing platform 1430 (e.g., NVIDIA's CUDA) may enable general purpose computing on GPUs (GPGPU) (e.g., GPUs/Graphics 1422). In at least one embodiment, a software layer of parallel computing platform 1430 may provide access to virtual instruction sets and parallel computational elements of GPUs, for execution of compute kernels. In at least one embodiment, parallel computing platform 1430 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1430 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 1418 may be leveraged to perform inferencing services for executing machine learning model(s) associated with applications (e.g., tasked with performing one or more processing tasks of an application). In at least one embodiment, AI service(s) 1418 may leverage AI system 1424 to execute machine learning model(s) (e.g., neural networks, such as CNNs) for segmentation, reconstruction, object detection, feature detection, classification, and/or other inferencing tasks. In at least one embodiment, applications of deployment pipeline(s) 1410 may use one or more of output model(s) 1316 from training system 1304 and/or other models of applications to perform inference on imaging data. In at least one embodiment, two or more examples of inferencing using application orchestration system 1428 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1428 may distribute resources (e.g., services 1320 and/or hardware 1322) based on priority paths for different inferencing tasks of AI service(s) 1418.

In at least one embodiment, shared storage may be mounted to AI service(s) 1418 within system 1400. In at least one embodiment, shared storage may operate as a cache (or other storage device type) and may be used to process inference requests from applications. In at least one embodiment, when an inference request is submitted, a request may be received by a set of API instances of deployment system 1306, and one or more instances may be selected (e.g., for best fit, for load balancing, etc.) to process a request. In at least one embodiment, to process a request, a request may be entered into a database, a machine learning model may be located from model registry 1324 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1412) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<10 min). In at least one embodiment, model execution times may be measured from requesting institution or entity and may include partner network traversal time, as well as execution on an inference service.

In at least one embodiment, transfer of requests between services 1320 and inference applications may be hidden behind a software development kit (SDK), and robust transport may be provided through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1426, and an inference service may perform inferencing on a GPU.

In at least one embodiment, visualization service(s) 1420 may be leveraged to generate visualizations for viewing outputs of applications and/or deployment pipeline(s) 1410. In at least one embodiment, GPUs/Graphics 1422 may be leveraged by visualization service(s) 1420 to generate visualizations. In at least one embodiment, rendering effects, such as ray-tracing, may be implemented by visualization service(s) 1420 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 1420 may include an internal visualizer, cinematics, and/or other rendering or image processing capabilities or functionality (e.g., ray tracing, rasterization, internal optics, etc.).

In at least one embodiment, hardware 1322 may include GPUs/Graphics 1422, AI system 1424, cloud 1426, and/or any other hardware used for executing training system 1304 and/or deployment system 1306. In at least one embodiment, GPUs/Graphics 1422 (e.g., NVIDIA's TESLA and/or QUADRO GPUs) may include any number of GPUs that may be used for executing processing tasks of compute service(s) 1416, AI service(s) 1418, visualization service(s) 1420, other services, and/or any of features or functionality of software 1318. For example, with respect to AI service(s) 1418, GPUs/Graphics 1422 may be used to perform pre-processing on imaging data (or other data types used by machine learning models), post-processing on outputs of machine learning models, and/or to perform inferencing (e.g., to execute machine learning models). In at least one embodiment, cloud 1426, AI system 1424, and/or other components of system 1400 may use GPUs/Graphics 1422. In at least one embodiment, cloud 1426 may include a GPU-optimized platform for deep learning tasks. In at least one embodiment, AI system 1424 may use GPUs, and cloud 1426—or at least a portion tasked with deep learning or inferencing—may be executed using one or more AI systems 1424. As such, although hardware 1322 is illustrated as discrete components, this is not intended to be limiting, and any components of hardware 1322 may be combined with, or leveraged by, any other components of hardware 1322.

In at least one embodiment, AI system 1424 may include a purpose-built computing system (e.g., a super-computer or an HPC) configured for inferencing, deep learning, machine learning, and/or other artificial intelligence tasks. In at least one embodiment, AI system 1424 (e.g., NVIDIA's DGX) may include GPU-optimized software (e.g., a software stack) that may be executed using a plurality of GPUs/Graphics 1422, in addition to CPUs, RAM, storage, and/or other components, features, or functionality. In at least one embodiment, one or more AI systems 1424 may be implemented in cloud 1426 (e.g., in a data center) for performing some or all of AI-based processing tasks of system 1400.

In at least one embodiment, cloud 1426 may include a GPU-accelerated infrastructure (e.g., NVIDIA's NGC) that may provide a GPU-optimized platform for executing processing tasks of system 1400. In at least one embodiment, cloud 1426 may include an AI system 1424 for performing one or more of AI-based tasks of system 1400 (e.g., as a hardware abstraction and scaling platform). In at least one embodiment, cloud 1426 may integrate with application orchestration system 1428 leveraging multiple GPUs to enable seamless scaling and load balancing between and among applications and services 1320. In at least one embodiment, cloud 1426 may tasked with executing at least some of services 1320 of system 1400, including compute service(s) 1416, AI service(s) 1418, and/or visualization service(s) 1420, as described herein. In at least one embodiment, cloud 1426 may perform small and large batch inference (e.g., executing NVIDIA's TENSOR RT), provide an accelerated parallel computing API and platform 1430 (e.g., NVIDIA's CUDA), execute application orchestration system 1428 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1400.

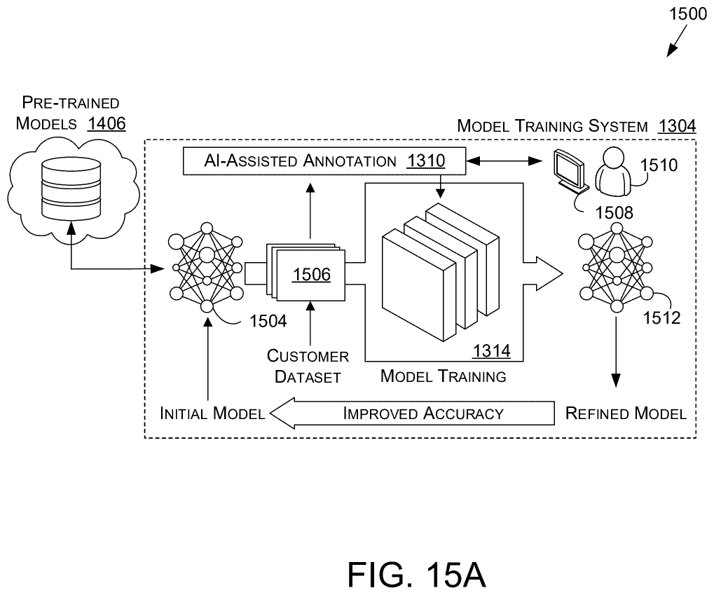

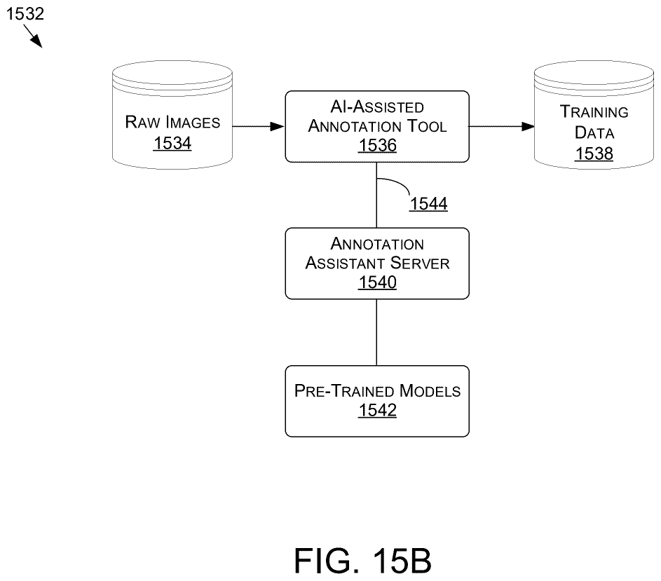

FIG. 15A illustrates a data flow diagram for a process 1500 to train, retrain, or update a machine learning model, in accordance with at least one embodiment. In at least one embodiment, process 1500 may be executed using, as a non-limiting example, system 1400 of FIG. 14. In at least one embodiment, process 1500 may leverage services and/or hardware as described herein. In at least one embodiment, refined models 1512 generated by process 1500 may be executed by a deployment system for one or more containerized applications in deployment pipelines.

In at least one embodiment, model training 1514 may include retraining or updating an initial model 1504 (e.g., a pre-trained model) using new training data (e.g., new input data, such as customer dataset 1506, and/or new ground truth data associated with input data). In at least one embodiment, to retrain, or update, initial model 1504, output or loss layer(s) of initial model 1504 may be reset, deleted, and/or replaced with an updated or new output or loss layer(s). In at least one embodiment, initial model 1504 may have previously fine-tuned parameters (e.g., weights and/or biases) that remain from prior training, so training or retraining 1514 may not take as long or require as much processing as training a model from scratch. In at least one embodiment, during model training 1514, by having reset or replaced output or loss layer(s) of initial model 1504, parameters may be updated and re-tuned for a new data set based on loss calculations associated with accuracy of output or loss layer(s) at generating predictions on new, customer dataset 1506.

In at least one embodiment, pre-trained models 1506 may be stored in a data store, or registry. In at least one embodiment, pre-trained models 1506 may have been trained, at least in part, at one or more facilities other than a facility executing process 1500. In at least one embodiment, to protect privacy and rights of patients, subjects, or clients of different facilities, pre-trained models 1506 may have been trained, on-premise, using customer or patient data generated on-premise. In at least one embodiment, pre-trained models 1506 may be trained using a cloud and/or other hardware, but confidential, privacy protected patient data may not be transferred to, used by, or accessible to any components of a cloud (or other off premise hardware). In at least one embodiment, where pre-trained models 1506 is trained at using patient data from more than one facility, pre-trained models 1506 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained models 1506 on-premise and/or off premise, such as in a datacenter or other cloud computing infrastructure.

In at least one embodiment, when selecting applications for use in deployment pipelines, a user may also select machine learning models to be used for specific applications. In at least one embodiment, a user may not have a model for use, so a user may select a pre-trained model to use with an application. In at least one embodiment, pre-trained model may not be optimized for generating accurate results on customer dataset 1506 of a facility of a user (e.g., based on patient diversity, demographics, types of medical imaging devices used, etc.). In at least one embodiment, prior to deploying a pre-trained model into a deployment pipeline for use with an application(s), pre-trained model may be updated, retrained, and/or fine-tuned for use at a respective facility.

In at least one embodiment, a user may select pre-trained model that is to be updated, retrained, and/or fine-tuned, and this pre-trained model may be referred to as initial model 1504 for a training system within process 1500. In at least one embodiment, a customer dataset 1506 (e.g., imaging data, genomics data, sequencing data, or other data types generated by devices at a facility) may be used to perform model training (which may include, without limitation, transfer learning) on initial model 1504 to generate refined model 1512. In at least one embodiment, ground truth data corresponding to customer dataset 1506 may be generated by training system 1304. In at least one embodiment, ground truth data may be generated, at least in part, by clinicians, scientists, doctors, practitioners, at a facility.

In at least one embodiment, AI-assisted annotation may be used in some examples to generate ground truth data. In at least one embodiment, AI-assisted annotation (e.g., implemented using an AI-assisted annotation SDK) may leverage machine learning models (e.g., neural networks) to generate suggested or predicted ground truth data for a customer dataset. In at least one embodiment, a user may use annotation tools within a user interface (a graphical user interface (GUI)) on a computing device.

In at least one embodiment, user 1510 may interact with a GUI via computing device 1508 to edit or fine-tune (auto)annotations. In at least one embodiment, a polygon editing feature may be used to move vertices of a polygon to more accurate or fine-tuned locations.

In at least one embodiment, once customer dataset 1506 has associated ground truth data, ground truth data (e.g., from AI-assisted annotation, manual labeling, etc.) may be used by during model training to generate refined model 1512. In at least one embodiment, customer dataset 1506 may be applied to initial model 1504 any number of times, and ground truth data may be used to update parameters of initial model 1504 until an acceptable level of accuracy is attained for refined model 1512. In at least one embodiment, once refined model 1512 is generated, refined model 1512 may be deployed within one or more deployment pipelines at a facility for performing one or more processing tasks with respect to medical imaging data.

In at least one embodiment, refined model 1512 may be uploaded to pre-trained models in a model registry to be selected by another facility. In at least one embodiment, this process may be completed at any number of facilities such that refined model 1512 may be further refined on new datasets any number of times to generate a more universal model.

FIG. 15B is an example illustration of a client-server architecture 1532 to enhance annotation tools with pre-trained annotation models, in accordance with at least one embodiment. In at least one embodiment, AI-assisted annotation tool 1536 may be instantiated based on a client-server architecture 1532. In at least one embodiment, AI-assisted annotation tool 1536 in imaging applications may aid radiologists, for example, identify organs and abnormalities. In at least one embodiment, imaging applications may include software tools that help user 1510 to identify, as a non-limiting example, a few extreme points on a particular organ of interest in raw images 1534 (e.g., in a 3D MRI or CT scan) and receive auto-annotated results for all 2D slices of a particular organ. In at least one embodiment, results may be stored in a data store as training data 1538 and used as (for example and without limitation) ground truth data for training. In at least one embodiment, when computing device 1508 sends extreme points for AI-assisted annotation, a deep learning model, for example, may receive this data as input and return inference results of a segmented organ or abnormality. In at least one embodiment, pre-instantiated annotation tools, such as AI-assisted annotation tool 1536 in FIG. 15B, may be enhanced by making API calls (e.g., API Call 1544) to a server, such as an Annotation Assistant Server 1540 that may include a set of pre-trained models 1542 stored in an annotation model registry, for example. In at least one embodiment, an annotation model registry may store pre-trained models 1542 (e.g., machine learning models, such as deep learning models) that are pre-trained to perform AI-assisted annotation on a particular organ or abnormality. These models may be further updated by using training pipelines. In at least one embodiment, pre-installed annotation tools may be improved over time as new labeled data is added.

Various embodiments can be described by the following clauses:
1. A system, comprising:
one or more processors to:
generate a digital representation of a physical data center in a digital simulation environment;
provide, as input to a machine learning model, information about a workflow to be performed in the physical data center, the machine learning model trained using benchmark data for a plurality of processing jobs performed using combinations of hardware in the physical data center;
execute, in the digital simulation environment, one or more simulations based in part upon one or more hardware architectures output from the machine learning model as being potentially optimal for running the workflow in the physical data center;
analyze performance data for the one or more simulations to determine whether the performance data satisfies one or more architecture selection criteria; and
perform one or more additional simulations using other potential hardware architectures, inferred by the machine learning model based in part upon the performance data for the one or more simulations, until the performance data for at least one of the simulations satisfies the one or more architecture selection criteria.
2. The system of clause 1, wherein the one or more processors are further to:
provide, as input to at least the machine learning model or the digital simulation environment, configuration data specifying at least operational parameters for hardware in the physical data center to be included in the digital representation.
3. The system of clause 1, wherein the one or more hardware architectures include different clusters of compute nodes in the physical data center, a number of the compute nodes in the different clusters being greater than were used to previously perform a similar workflow at a smaller scale.
4. The system of clause 1, wherein the machine learning model outputs data indicating a range of hardware architecture options, allowing a user to select a hardware architecture option within the range.
5. The system of clause 1, wherein the one or more architecture selection criteria include a target cost, level of performance, or number of processing nodes to be used to perform the workflow.
6. The system of clause 1, wherein the digital representation is a digital twin of the physical data center including a virtual three-dimensional representation of a set of connected functional components of the physical data center.
7. The system of clause 1, wherein the workflow relates to a job that is to be run for at least a minimum period of time and has an anticipated load over the minimum period of time.
8. The system of clause 1, wherein the one or more processors are further to:
collect telemetry data for the data center during at least one of simulation or operation; and
update at least one of the digital representation, configuration data for the data center, or the machine learning model using the telemetry data.
9. A simulation environment, comprising:
one or more processing units to execute a plurality of simulations of a data center running an anticipated workflow, the plurality of simulations having different hardware architectures inferred using a machine learning model trained using benchmark data for other jobs previously performed using various combinations of hardware, the machine learning model to infer additional potential hardware architectures based in part upon performance data for the plurality of simulations until at least one hardware architecture is identified that satisfies at least one architecture selection criterion.
10. The simulation environment of clause 9, wherein the one or more processing units are further configured to:
provide, as input to at least the machine learning model or the simulations, configuration data specifying at least operational parameters for hardware in the data center to be included in a digital representation of the data center.
11. The simulation environment of clause 9, wherein the one or more hardware architectures include different clusters of compute nodes in the data center, a number of the compute nodes in the different clusters being greater than were used to previously perform a similar workflow at a smaller scale.
12. The simulation environment of clause 9, wherein the machine learning model outputs data indicating a range of hardware architecture options, allowing a user to select a hardware architecture option within the range.
13. The simulation environment of clause 9, wherein the one or more architecture selection criterion include a target cost, level of performance, or number of processing nodes to be used to perform the workflow.
14. The simulation environment of clause 9, wherein the simulation is a digital twin of the data center including a virtual three-dimensional representation of a set of connected functional components of the data center.
15. The simulation environment of clause 9, wherein the anticipated workflow relates to a job that is to be run for at least a minimum period of time and has an anticipated load over the minimum period of time.
16. A method comprising:
creating a virtual model representing a data center within a simulated digital environment;
inputting, for processing by machine learning model, details regarding an operational process to be executed within a physical infrastructure, the machine learning model trained using one or more reference data associated with various tasks carried out utilizing different configurations of the data center;
generating simulations within the simulated digital environment of one or more system configurations identified by the machine learning model as being potentially effective for executing the operational process in the data center;
evaluating performance metrics generated from the simulations to determine whether the performance metrics meet one or more data center criteria; and
generating further simulations employing one or more alternative data center configurations suggested by machine learning model based on one or more insights derived from the performance metrics until the performance metrics align with the data center criteria for data center selection.
17. The method of clause 16, further comprising:
providing, as input to at least the machine learning model or the simulations, configuration data specifying at least operational parameters for hardware in the data center to be included in a digital representation of the data center.
18. The method of clause 16, wherein the one or more system configurations include different clusters of compute nodes in the data center, a number of the compute nodes in the different clusters being greater than were used to previously perform a similar workflow at a smaller scale.
19. The method of clause 16, wherein the machine learning model outputs data indicating a range of hardware architecture options, allowing a user to select a hardware architecture option within the range.
20. The method of clause 16, wherein the simulation is a digital twin of the data center including a virtual three-dimensional representation of a set of connected functional components of the data center.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors-for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system, comprising:
one or more processors to:
generate a digital representation of a physical data center in a digital simulation environment;
provide, as input to a machine learning model, information about a workflow to be performed in the physical data center, the machine learning model trained using benchmark data for a plurality of processing jobs performed using combinations of hardware in the physical data center;
execute, in the digital simulation environment, one or more simulations based in part upon one or more hardware architectures output from the machine learning model as being potentially optimal for running the workflow in the physical data center;
analyze performance data for the one or more simulations to determine whether the performance data satisfies one or more architecture selection criteria; and
perform one or more additional simulations using other potential hardware architectures, inferred by the machine learning model based in part upon the performance data for the one or more simulations, until the performance data for at least one of the simulations satisfies the one or more architecture selection criteria.

2. The system of claim 1, wherein the one or more processors are further to:
provide, as input to at least the machine learning model or the digital simulation environment, configuration data specifying at least operational parameters for hardware in the physical data center to be included in the digital representation.

3. The system of claim 1, wherein the one or more hardware architectures include different clusters of compute nodes in the physical data center, a number of the compute nodes in the different clusters being greater than were used to previously perform a similar workflow at a smaller scale.

4. The system of claim 1, wherein the machine learning model outputs data indicating a range of hardware architecture options, allowing a user to select a hardware architecture option within the range.

5. The system of claim 1, wherein the one or more architecture selection criteria include a target cost, level of performance, or number of processing nodes to be used to perform the workflow.

6. The system of claim 1, wherein the digital representation is a digital twin of the physical data center including a virtual three-dimensional representation of a set of connected functional components of the physical data center.

7. The system of claim 1, wherein the workflow relates to a job that is to be run for at least a minimum period of time and has an anticipated load over the minimum period of time.

8. The system of claim 1, wherein the one or more processors are further to:
collect telemetry data for the data center during at least one of simulation or operation; and
update at least one of the digital representation, configuration data for the data center, or the machine learning model using the telemetry data.

9. A simulation environment, comprising:
one or more processing units to execute a plurality of simulations of a data center running an anticipated workflow, the plurality of simulations having different hardware architectures inferred using a machine learning model trained using benchmark data for other jobs previously performed using various combinations of hardware, the machine learning model to infer additional potential hardware architectures based in part upon performance data for the plurality of simulations until at least one hardware architecture is identified that satisfies at least one architecture selection criterion.

10. The simulation environment of claim 9, wherein the one or more processing units are further configured to:
provide, as input to at least the machine learning model or the simulations, configuration data specifying at least operational parameters for hardware in the data center to be included in a digital representation of the data center.

11. The simulation environment of claim 9, wherein the one or more hardware architectures include different clusters of compute nodes in the data center, a number of the compute nodes in the different clusters being greater than were used to previously perform a similar workflow at a smaller scale.

12. The simulation environment of claim 9, wherein the machine learning model outputs data indicating a range of hardware architecture options, allowing a user to select a hardware architecture option within the range.

13. The simulation environment of claim 9, wherein the one or more architecture selection criterion include a target cost, level of performance, or number of processing nodes to be used to perform the workflow.

14. The simulation environment of claim 9, wherein the simulation is a digital twin of the data center including a virtual three-dimensional representation of a set of connected functional components of the data center.

15. The simulation environment of claim 9, wherein the anticipated workflow relates to a job that is to be run for at least a minimum period of time and has an anticipated load over the minimum period of time.

16. A method comprising:
creating a virtual model representing a data center within a simulated digital environment;
inputting, for processing by machine learning model, details regarding an operational process to be executed within a physical infrastructure, the machine learning model trained using one or more reference data associated with various tasks carried out utilizing different configurations of the data center;
generating simulations within the simulated digital environment of one or more system configurations identified by the machine learning model as being potentially effective for executing the operational process in the data center;
evaluating performance metrics generated from the simulations to determine whether the performance metrics meet one or more data center criteria; and
generating further simulations employing one or more alternative data center configurations suggested by machine learning model based on one or more insights derived from the performance metrics until the performance metrics align with the data center criteria for data center selection.

17. The method of claim 16, further comprising:
providing, as input to at least the machine learning model or the simulations, configuration data specifying at least operational parameters for hardware in the data center to be included in a digital representation of the data center.

18. The method of claim 16, wherein the one or more system configurations include different clusters of compute nodes in the data center, a number of the compute nodes in the different clusters being greater than were used to previously perform a similar workflow at a smaller scale.

19. The method of claim 16, wherein the machine learning model outputs data indicating a range of hardware architecture options, allowing a user to select a hardware architecture option within the range.

20. The method of claim 16, wherein the simulation is a digital twin of the data center including a virtual three-dimensional representation of a set of connected functional components of the data center.
